(19) United States
(12) Patent Application Publication
(10) Pub. No.: US 2012/0003146 A1
(43) Pub. Date: Jan. 5, 2012

(54) NATURALLY-OCCURRING NANOMATRIX BIOMATERIALS AS CATALYSTS

(75) Inventor: Carl B. Fliermans, Augusta, GA (US)

(73) Assignee: MICROBES UNLIMITED, LLC, Augusta, GA (US)

(21) Appl. No.: 12/830,180

(22) Filed: Jul. 2, 2010

(51) Int. Cl. C01B 3/02; B01J 8/02; B01J 21/08; B01J 21/06; B82Y 30/00

(52) U.S. Cl. 423/648.1; 502/232; 502/262; 502/351; 502/202; 422/211; 977/773

(57) ABSTRACT

This disclosure provides systems, methods, and compositions for facilitating hydrogen storage, typically using naturally-occurring nanostructured biomaterials such as diatoms or diatomaceous material in their natural or modified forms to facilitate the hydrogen storage. For example, when the nanostructured biomaterials are in contact with a metal hydride such as a complex or a simple metal hydride, the resulting composition functions a catalytic composition that can reversibly desorb and resorb hydrogen gas in an efficient manner. Examples of modification include, but are not limited to, modification of the nanostructured silica with any number of metals.

### GOVERNMENT LICENSE RIGHTS

Inventions described herein or otherwise based on this patent application may fall under Cooperative Research and Development Agreement CR-07-002 between Microbes Unlimited, LLC, and Savannah River National Laboratory, operated for the United States Department of Energy under Prime Contract DE-AC09-08SR22470 between Savannah River Nuclear Solutions, LLC (SRNS) and the U.S. Department of Energy. The U.S. Government may retain certain license rights in this application.

### FIELD OF THE INVENTION

This application relates generally to hydrogen storage, and more particularly, to systems and methods for facilitating hydrogen storage using nanostructure assemblies.

### BACKGROUND OF THE INVENTION

The dependency on limited sources of oil and other carbon-based energy resources may hinder future economic growth and security for many nations. To advance towards independent energy economies, nations are considering alternative energy sources such as hydrogen. Hydrogen offers a promising solution, but there is currently a lack of suitable carriers for hydrogen that have a relatively high-energy density and low cost for vehicle storage application. Transport and an onboard vehicular storage of hydrogen (H₂) is a well-known bottleneck and one limiting factor in developing a hydrogen-based economy. The current lack of convenient, safe and cost effective materials and methods to store hydrogen has limited the widespread use of hydrogen as a fuel and as a mode for energy storage.

Guideline objectives published by the United States Department of Energy (USDOE) for hydrogen storage capacity for vehicle transportation have not yet been met by conventional technologies because of various size constraints, recharge kinetics, cost and/or safety issues. One example of such conventional technologies includes the use of nanoporous metal-organic frameworks (MOFs) that enhance the adsorption of supercritical H₂. This appears to be accomplished by overlapping the charged potential fields from both sides of the pore structure to enhance the interaction potential. Another example of such conventional technologies includes the use of titanium alloys as hydrogen storage solids. However, neither of these conventional technologies has proven production practical for hydrogen storage with respect to meeting or exceeding the USDOE guideline objectives.

Other attempts to achieve suitable hydrogen storage capacities involve laboratory prepared nanomaterials and composite materials, which have provided hydrogen storage capacities at near ambient conditions. For example, one system uses ethylene gas to prepare carbon nanofibers having varying widths and lengths for this application. However, the consistent production of these laboratory prepared nanomaterials is not adequately controllable, and the expense of creating such materials can be very high, currently thousands of dollars per gram of material. Thus, such conventional composite materials are sometimes plagued by a lack of reproducibility and viable economics for larger-scale production. Another drawback to using such conventional nanomaterials has been the difficulty in controlling their synthesis while preserving the nanoscale integrity of the subsequent assembly.

Therefore, a need exists for systems and methods for facilitating hydrogen storage using nanostructure assemblies that may address some of these issues. If possible, such hydrogen storage systems would be applicable to the catalytic systems in industrial applications, and to catalytic devices for use in internal combustion engines of all sizes. One desirable hydrogen storage system would be applicable to small engines as well, such as lawn mowers, All-Terrain-Vehicles (ATVs), motorcycles, golf carts, and the like.

### SUMMARY OF THE INVENTION

This disclosure provides systems, methods, and compositions for facilitating hydrogen storage, which involve using naturally-occurring nanostructured assemblies in their natural (unmodified) or modified forms to facilitate the hydrogen storage and catalytic activity. Materials which provide these naturally-occurring nanostructured assemblies include materials referred to as nanostructured biomaterials, indicating their biological origin and their structural elements, such as pores, channels, bands, and the like, which are on the nanometer scale (nanoscale).

Generally and in some embodiments, this disclosure provides for selecting microorganisms such as diatoms as the biomaterials, and utilizing their nanostructure assemblies in their modified and/or unmodified forms to facilitate or effect hydrogen storage and release. These naturally-occurring eukaryotic algae can provide a convenient, inexpensive, and large scale source to nanostructured assemblies. Modified nanostructure assemblies which may mimic the original unmodified diatom nanostructures in certain ways, also can facilitate or catalyze hydrogen storage and release under readily controllable conditions. In this manner, hydrogen may be stored, used as a fuel, and ultimately recharged into storage, thereby providing fuel systems for vehicles, other energy consuming devices, fuel cells for electrical consuming systems, and the portable transport of energy. This type of storage structure may be inherently safe and could provide relatively high-energy density storage for hydrogen.

In some aspects, this disclosure provides for the use of nanostructured biomaterials, in their modified or unmodified forms, in combination with “complex” hydrides such as salts of [AlH₄]⁻ and/or [BH₄]⁻, or “simple” hydrides such as LiH, NaH, or CaH₂. For example, when complex hydrides such as LiAlH₄, NaAlH₄, KAlH₄, LiBH₄, NaBH₄, and the like are combined or doped with various types of nanostructured inorganic materials, such as nanostructured biomaterials, to form a composite, the composite can exhibit reversible and repeatable hydrogen sorption and desorption activity under relatively mild conditions.

Examples of suitable nanostructured biomaterials include diatomaceous earth (silica diatomaceous earth), titania diatomaceous earth, and zirconia diatomaceous earth, all of which exhibit hydrogen sorption-desorption properties, making these materials useful for catalytic activity, hydrogen storage devices and methods. In one aspect, favorable kinetics for hydrogen sorption-desorption are obtained when using hydrides such as NaAlH₄ doped with inorganic nanostructured materials such as nanostructured biomaterials. For example, studies on NaAlH₄ doped with various types of diatomaceous earth (silicate and anatase) as well as commercially-available anatase nanopowder, have shown material morphology and elemental composition may be aspects that can be adjusted to enhance catalytic hydrogen sorption. Thus, both anatase and silicate based materials with appreciable nanostructure (e.g. diatoms and nanopowder) show catalytic hydrogen desorption properties, but materials without nanostructure are weakly catalytic. All elements in the periodic chart or in theses series or families are applicable. Diatoms outside of the geological deposit can be used by growing the diatoms as a renewable resources.

In another aspect, this disclosure provides for modifying the naturally-occurring silica nanostructure assemblies of these biomaterials by metathesis or exchange reactions, which replace some or substantially all of the silica atoms in the nanostructure network with other atoms such as electropositive atoms, including metal atoms like titanium, vanadium, zirconium, or hafnium. As well as all metals used in catalytic converters. For example, a diatomaceous biomaterial's naturally-occurring silica nanostructure assembly can be modified to form an anatase (titanium dioxide) nanostructure assembly that can promote the reversible uptake and release of hydrogen. As detailed herein, a range of atoms and substances can be employed to modify the naturally-occurring silica nanostructure assembly.

In a further aspect, this disclosure also provides for modifying the naturally-occurring silica nanostructure assemblies of biomaterials by deposition reactions in which, for example, metal atoms, ions, clusters, nanoparticles, or metal-containing molecules may be deposited on or in the nanostructured biomaterial. In this aspect, for example, metals can be deposited from solution or vapor phase deposition processes to afford a modified nanostructured biomaterial in which the surface, pores, channels, bands, and the like, may include coatings, islands, or clumps of deposited metal atoms, ions, clusters, nanoparticles, or metal-containing molecules. Examples of this approach include modifying a nanostructured biomaterial by depositing a platinum metal, a coinage metal, or other metals on or in the nanostructures to provide a modified nanostructured biomaterial having metal nanoparticles associated with the biomaterial. We note that the recited metals such as the platinum metals, are not limited to forming this type of deposition modification of a nanostructured biomaterial.

Further, a combination of these methods for modifying the naturally-occurring silica nanostructure assemblies of biomaterials is encompassed by this disclosure. For example, this disclosure provides for catalytic compositions, methods, and devices in which at least some of the nanostructured biomaterials are modified nanostructured silica having at least partial substitution of the silicon atoms by non-silicon metal atoms in the nanostructure, and at least some of the nanostructured biomaterial is a modified nanostructured silica having non-silicon metal nanoparticles associated with the nanostructured silica. In one aspect, the catalytic compositions can be catalytic hydrogen storage compositions.

In still a further aspect of these biomaterials, there is provided a novel nano-structured catalyst composition based on these biomaterials, the catalyst system including a combination of a nanostructured assembly such as those derived from a biomaterial and a hydride source such as a simple or complex metal hydride. In an embodiment, the nanostructured oxide material and the hydride source are combined or contacted to provide the catalyst composition. In this aspect, the biomaterials modified by the metathesis or exchange reactions can be used to prepare nano-structured catalyst systems of this type. By way of example, a catalyst system comprising a combination of anatase (titanium dioxide) diatomaceous biomaterials and a boron tetrahydride (tetrahydrido borate) or an aluminum tetrahydride (tetrahydrido aluminate) exhibits reversible and facile hydrogen sorption properties. While not intending to be bound by theory, it is believed that reduction or at least partial reduction of the nano-oxide material occurs to generate structures that are highly efficient catalyst systems, in which the dehydriding temperatures are lowered and the dehydriding kinetics are enhanced, making these systems viable hydrogen storage systems. Other elemental substitutions can be effected in precursor biomaterials to provide new catalyst system combinations of nanostructured assemblies and hydride sources.

Various embodiments encompassed in this disclosure can include or otherwise facilitate, safely storing hydrogen in recyclable and exchangeable canisters containing diatoms or naturally occurring or modified nanostructure assemblies, such as the catalyst systems that contain these diatoms or nanostructure assemblies described herein. These materials or systems can provide a renewable structure for hydrogen storage under near ambient temperatures and pressures. Hydrogen bound on or within such materials, compositions, or structures can be provided in canister form where, for example, vehicle “fill-ups” would comprise exchanging pre-filled hydrogen canisters. Additionally, these embodiments may be used to facilitate mobile energy sources for electrical supply.

In other embodiments there is provided a method for storing hydrogen. The method can include providing diatoms comprising diatomaceous earth or diatoms from a predefined culture. For example, the method can include heating the diatoms in a sealed environment in the presence of at least one of a transition metal such as titanium or zirconium, an alkali metal, an alkaline earth metal, a transition metal, a lanthanide, an actinide, and/or a main group metal to provide a porous hydrogen storage medium or composition. Furthermore, the method can include exposing the porous hydrogen storage medium to hydrogen. The method can further include using the diatoms or the modified diatoms in combination with a hydride source such as a metal hydride, to provide a catalyst system as disclosed herein, which also functions as a porous hydrogen storage medium. Furthermore, the method can include exposing any of the porous hydrogen storage media to hydrogen. In addition, the method can include storing at least a portion of the hydrogen in the porous hydrogen storage medium. Diatoms can be selected for differing pore sizes, structure and number to best facilitate the methodology.

In another embodiment, a system for storing hydrogen can be provided. The system can include a hydrogen source and a sealed environment. The sealed environment can be operable to receive at least one substrate comprising at least one porous hydrogen storage medium or composition as provided herein. The system also can include an environmental control system operable to control the pressure or temperature within the sealed environment, wherein the at least one substrate stores hydrogen upon simultaneous heating of the substrate and exposure of the substrate to hydrogen. For example, the porous hydrogen storage media or composition can comprise or consist of a plurality of diatoms arranged in a nanostructure assembly; a plurality of diatoms and a plurality of at least one of a transition metal, an alkali metal, an alkaline earth metal, a lanthanide, an actinide, and/or a main group metal within the nanostructure assembly; either of the previous two materials in further combination with at least one hydride source; or any combination thereof.

In at least one aspect of an embodiment, hydrogen can be stored for certain durations of time with or without increased temperature, increased pressure, or a combination of each variable of temperature and pressure.

In a further aspect, this disclosure provides for a catalytic composition, including but not limited to a catalytic hydrogen storage composition, comprising at least one modified or unmodified nanostructured biomaterial in contact with at least one hydride source. For example, the at least one nanostructured biomaterial can be selected from an unmodified nanostructured silica or can be selected from a nanostructured silica modified with at least one non-silicon element such as a non-silicon metal.

In yet another aspect, this disclosure also provides for a hydrogen storage system, the system comprising:
a sealed environment operable to receive a catalytic composition comprising at least one modified or unmodified nanostructured biomaterial in contact with at least one hydride source;
a hydrogen source; and
an environmental control system operable to control the pressure of hydrogen and/or temperature within the sealed environment,
wherein the catalytic composition stores hydrogen upon heating and exposure to hydrogen.

In this aspect, for example, the environmental control system can be operable to release at least a portion of the stored hydrogen from within the sealed environment by a process comprising subjecting the at least one modified or unmodified nanostructured biomaterial in contact with at least one hydride source to a predefined temperature and pressure. The environmental control system also can be operable to re-expose the at least one modified or unmodified nanostructured biomaterial in contact with at least one hydride source to hydrogen; and store at least a portion of the hydrogen in the hydrogen storage medium.

According to still another aspect, this disclosure provides a method for storing hydrogen, the method comprising:
providing a catalytic composition comprising at least one modified or unmodified nanostructured biomaterial in contact with at least one hydride source;
exposing the catalytic hydrogen storage composition to hydrogen; and
storing at least a portion of the hydrogen in the catalytic composition.
   This general method is also applicable to the storage of deuterium or tritium.

The at least one nanostructured biomaterial can be any of the nanostructured biomaterials disclosed herein, or any combination thereof.

Other systems, processes, devices, and apparatus according to various embodiments of the invention will become apparent with respect to the remainder of this document.

### BRIEF DESCRIPTION OF THE DRAWINGS

Having described some of the various embodiments encompassed in this disclosure in general terms, reference will now be made to the accompanying drawings, which are not necessarily drawn to scale, and wherein:

FIG. 1 is an exemplary hydrogen storage system in accordance with a disclosed embodiment.

FIG. 2 is an exemplary apparatus in accordance with a disclosed embodiment.

FIG. 3 is a flowchart of an exemplary process in accordance with a disclosed embodiment.

FIG. 4 is a flowchart of an exemplary process in accordance with a disclosed embodiment.

FIG. 5 is a flowchart of an exemplary process in accordance with a disclosed embodiment.

FIGS. 6(A)-(C) illustrate sequential temperature programmed desorption (TPD) profiles of the 20 wt % NaAlH₄-diatom composite with a temperature ramp at 2° C./min to 300° C.; (D)-(E) illustrate sequential TPD run profiles of pure NaAlH₄ shown for comparison.

FIG. 7 provides a scanning electron microscope (SEM) image of the Pd-modified diatoms.

FIG. 8 illustrates a temperature programmed desorption (TPD) plot of a Pd-diatom composite with temperature ramp of 2° C./min to 150° C. illustrated in the upper line, and the corresponding wt % hydrogen released illustrated in the lower curve.

FIGS. 9(A)-(B) illustrate sequential temperature programmed desorption (TPD) plots of Ti-substituted diatoms with temperature ramp at 2° C./min to 300° C.

FIG. 10 illustrates a powder X-ray diffraction (XRD) pattern of the as-prepared Ti-diatom doped (4 mol %) NaAlH₄.

FIG. 11 provides a powder X-ray diffraction (XRD) pattern of dehydrided Ti-diatom doped (4 mol %) NaAlH₄.

FIG. 12 illustrates a powder X-ray diffraction (XRD) pattern of rehydrided Ti-diatom doped (4 mol %) NaAlH₄.

FIG. 13 provides a scanning electron microscope (SEM) images of titanium substituted diatoms post anneal.

FIGS. 14(A)-(C) illustrate sequential temperature programmed desorption (TPD) profile data of a 4 mol % NaAlH₄ doped Ti-diatom composite with a temperature ramp at 2° C./min to 300° C.; (D)-(E) illustrate sequential TPD profile standards of pure NaAlH₄ shown for comparison.

FIG. 15 demonstrates the extended dehydriding/rehydriding cycling of a 4 mol % NaAlH₄ doped Ti-diatom composite, with only the temperature programmed desorption (TPD) step shown (temperature ramp of 2° C./min to 300° C.). Plots (A)-(F) illustrate sequential desorption TPD run profiles of the composite.

FIG. 16 demonstrates the dehydriding/rehydriding cycling of a anatase nanopowder (1:1) NaAlH₄ composite with only the temperature programmed desorption (TPD) step shown, with a temperature ramp of 2° C./min to 300° C. Plots (A)-(E) illustrate sequential desorption TPD run profiles of the composite.

FIG. 17 is a plot of the thermogravimetric analysis (TGA) measurement of a TiO₂ nanopowder (4 mol %) NaAlH₄ composite, using a ramp rate 5° C./min.

FIGS. 18(A)-(C) illustrate sequential temperature programmed desorption (TPD) plots of dehydriding/rehydriding cycling of an anatase nanopowder (4 mol %) NaAlH₄ composite with only the temperature programmed desorption step shown (temperature ramp of 2° C./min to 300° C.).

FIGS. 19(A)-(C) illustrate sequential the temperature programmed desorption (TPD) plots of dehydriding/rehydriding cycling of a anatase powder (4 mol %) NaAlH₄ composite with only the temperature programmed desorption step shown (temperature ramp of 2° C./min to 300° C.); (D)-(E) illustrate sequential TPD profile standards of NaAlH₄ shown for comparison.

FIG. 20 provides a scanning electron microscope (SEM) images of as-received TiO₂ nanopowder (left) and sinter TiO₂ material post ball milling (right), both from Strem, Inc.

FIGS. 21(A)-(C) illustrate sequential temperature programmed desorption (TPD) plots of dehydriding temperature programmed desorption measurement of a Ti-diatom (4 mol %) LiBH₄ composite (temperature ramp of 2° C./min to 380° C.). The top line illustrates the temperature ramp of 2° C./min to 380° C.

FIGS. 22(A)-(C) illustrates sequential plots for the extended dehydriding temperature programmed desorption (TPD) measurement of a Ti-diatom (4 mol %) LiBH₄ composite (temperature ramp of 2° C./min to 380° C.) with a 15 h isotherm at 380° C. The top line illustrates the temperature ramp of 2° C./min to 380° C.

### DETAILED DESCRIPTION OF EMBODIMENTS OF THE INVENTION

In one aspect, this disclosure relates to catalytic compositions, methods, and systems that utilized nanostructured biomaterials and their compositions as catalysts to effect a number of catalytic reactions, such as hydrogen storage and release. According to various embodiments, this disclosure provides for a catalytic composition such as a catalytic hydrogen storage composition that comprises, consists of, or consists essentially of, at least one modified or unmodified nanostructured biomaterial in contact with at least one hydride source. For example, the at least one nanostructured biomaterial can be an unmodified nanostructured silica or a nanostructured silica modified with at least one non-silicon metal. Examples of modification include, but are not limited to, nanostructured silica having at least partial substitution of the silicon atoms by non-silicon metal atoms in the nanostructure; nanostructured silica having non-silicon metal nanoparticles associated with the nanostructured silica; or a combination thereof.

When the disclosed nanostructured biomaterials are combined or in contact with a metal hydride such as a complex metal hydride, the resulting composition functions a catalytic composition that can reversibly desorb and resorb hydrogen gas in an efficient manner. For example, using titanium-modified nanostructured biomaterials such as an anatase diatomaceous material, in combination with at least one metal hydride such as such as LiAlH₄, NaAlH₄, KAlH₄, LiBH₄, NaBH₄, and the like, this combination may be referred to herein as a composite, and this composite can exhibit reversible and repeatable hydrogen sorption and desorption activity under relatively mild conditions.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Terms such as nanostructure or nanostructured assemblies, biomaterials, biomatrices, diatoms, and the like, including their pluralized forms and their variations such as nanomatrix biomaterials or nano-biomatrices, can be used interchangeably herein. Among other things, these terms refer to the internal structure of a diatom including the nanometer sized diatom features, particularly pores, as well as any structural features that contribute to the formation of the nanoscale pores, such as any channels, bands, pillars, frustules, epitheca, hypotheca, valves, girdle bands, slits, and the like. Reference to a nanostructured materials includes these individual structural features, which may be disclosed or claimed individually and Applicant(s) reserve the right to proviso out or exclude any individual members of such a group of features. Reference to biomaterials or assemblies is intended to reflect that diatoms are the prototypical nanostructured biomaterial, and their description as nanostructured is further intended to reflect the particular scale of the structural features such as pores and channels found in diatoms, whether in natural form or modified as disclosed herein. Thus, even if the patterns in their silica structures extend beyond nanometer scale to encompass micronscale (or “microscale”) structural features, for convenience, such materials are referred to herein as nanostructured or nanoscale biomaterials. For example, pore sizes of the nanostructured biomaterials that are useful can be from less than 1 to 3000 nm, from 2 to 2500 nm, from 5 to 2000 nm, from 10 to 1500 nm, from 25 to 1000 nm, from 50 to 900 nm, or from 75 to 800 nm, from 100 to 700 nm, from 125 to 600 nm, or from 150 to 500 nm.

The term hydride source refers to a compound or composition having at least one formal hydride (H⁻) ligand or hydride-containing component, in association with a counter ion or ions, regardless of whether that compound or composition is considered to exist as: (1) a salt or ionic compound such as such as LiH, NaH, CaH₂, and the like, which also may be referred to as “simple” or ionic hydride sources or binary hydride sources; (2) a formal hydride-containing complex anion, or “coordination anion,” with associated counter ion(s), which may be referred to as a “complex” hydride source; (3) either a simple or complex hydride that may exist as a dihydrogen compound or complex under any conditions; (4) a main group or transition metal hydride, whether simple or complex; or (5) any combination thereof. Accordingly, hydride sources generally are described according to their stoichiometry and not according to any specific bonding mode or structure, because the detailed structure of many of these hydride sources is not known. Thus, terms such as hydride source, hydride compound, or hydride-containing coordination anion do not assume any particular structure, such as bridging versus terminal hydride structures and does not require formal hydrido ligands versus dihydrogen ligands. The hydride-containing coordination anion can contain ligands other than hydride, for example, [BH₄]⁻ and [BEt₃H]⁻ are both hydride-containing coordination anions, that may be referred to as complex hydride sources. The term complex hydride may be used to distinguish a compound having a hydride-containing coordination anion such as NaAlH₄ from a simple ionic hydride compound such as LiH, NaH, CaH₂, and the like.

Reference to a hydrogen storage medium or hydrogen storage media is intended to refer to a hydrogen storage composition, that is, a catalytic composition that is useful for hydrogen storage, and these terms are used interchangeably.

Terms such as diatomic or diatomic material are used interchangeably with the terms diatomaceous and diatomaceous material. Diatomaceous earth is an example of a “diatomic” or “diatomaceous” material.

The terms fixate and fix are generally used interchangeably to refer to the association of one material to another material. For example, various metals are described as being fixated, or fixed, to the silica in the diatoms.

The groups of the periodic table referred to herein reflect the standard International Union of Pure and Applied Chemistry (IUPAC) group numbers, from Group 1 to Group 18, which do not use the A or B section terminology of the periodic table.

Unless otherwise specified, any carbon-containing group for which the number of carbon atoms is not specified can have, according to proper chemical knowledge and practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. Additional identifiers or qualifying terms may be used to indicate the presence or absence of a particular substituent, the presence of absence of a branched underlying structure or backbone, and the like.

An alkyl group, which is usually abbreviated “R,” is used in accordance with its usual definition, as specified by IUPAC: a univalent group formed by removing a hydrogen atom from an alkane. Unless otherwise specified, the general term alkyl group includes linear, branched, and cyclic alkyl groups, and includes unsubstituted and substituted alkyl groups, any of which generally can have up to 30 carbon atoms. Any disclosure of an alkyl group also encompasses all structural isomers, conformational isomers, and stereoisomers that may arise, unless indicated otherwise. By way of example, an alkyl group can be a C₁ to C₂₀ alkyl, a C₁ to C₁₅ alkyl, a C₁ to C₁₂ alkyl, a C₁ to C₁₀ alkyl, a C₁ to C₈ alkyl, a C₁ to C₆ alkyl, or a C₁ to C₄ alkyl group, including substituted and unsubstituted aryl groups.

An aryl group, which is usually abbreviated “Ar,” is a univalent group derived from the formal removal of a hydrogen atom from an aromatic hydrocarbon ring carbon atom from an arene compound. Unless otherwise specified, the general term aryl group includes monocyclic and polycyclic aryl groups, and includes unsubstituted and substituted aryl groups, any of which generally can have up to 30 carbon atoms. Any disclosure of an aryl group also encompasses all structural isomers, conformational isomers, and stereoisomers that may arise, for example, from a particular set of substituents, unless indicated otherwise. By way of example, an aryl group can be a C₆ to C₂₀ aryl, a C₆ to C₁₅ aryl, a C₆ to C₁₂ aryl, a C₆ to C₁₀ aryl, or a C₆ to C₈ aryl group, including substituted and unsubstituted aryl groups.

A halide has its usual meaning according to the IUPAC definition. Examples of halides include fluoride, chloride, bromide, and iodide.

An alkoxide group is an oxygen-bonded group having the general formula (—OR), where “R” is an alkyl group as defined herein.

An aryloxide group is an oxygen-bonded group having the general formula (—OAr), where “Ar” is an aryl group as defined herein.

The alkali metals are the Group 1 elements, and include lithium, sodium, potassium, rubidium, and cesium.

The alkaline earth metals are the Group 2 elements and include magnesium, calcium, strontium, and barium.

The transition metals are the Groups 3-12 elements and include scandium, yttrium, lanthanum, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Thus, the Group 3 elements scandium, yttrium, lanthanum are included among the “transition metals.” Subsets of the transition metals include the platinum metals, the noble metals, and the coinage metals.

The platinum metals are defined herein as ruthenium, osmium, rhodium, iridium, palladium, and platinum.

The noble metals are defined herein as the platinum metals plus silver and gold. Thus, the noble metals are ruthenium, osmium, rhodium, iridium, palladium, platinum, silver, and gold.

The coinage metals are defined herein as copper, silver, and gold.

The lanthanides are elements having atomic numbers 58 through 71, that is, the fourteen (14) elements following lanthanum in the periodic table of the elements. The lanthanides include cerium, praseodymium, neodymium, promethium, samarium, europium, gadolinium, terbium, dysprosium, holmium, erbium, thulium, ytterbium, and lutetium.

The actinides are elements having atomic numbers 90 through 103, that is, the fourteen (14) elements following actinium in the periodic table of the elements. For practical reasons related to the stability of the elements, the disclosure that the actinides can be used in the compositions and methods refers to the elements thorium, protactinium, and uranium.

The main group “metals” refers to those elements of Groups 13-16 that are normally considered as metals and semimetals (metalloids), and includes boron, aluminum, gallium, indium, thallium, silicon, germanium, tin, lead, arsenic, antimony, bismuth, and tellurium. Thus, while silicon is generally considered a main group semimetal, reference to modifying a naturally occurring (SiO₂) diatom with a main group metal, generally is intended to not include silicon among the main groups for this purpose, unless specifically stated otherwise. For example, modification a naturally occurring (SiO₂) diatom with isotopically-enriched ²⁹Si, ³⁰Si, or ³²Si is envisioned for specific labeling studies that require a certain isotope; however, such metathesis reactions and products will be specifically stated if intended.

Reference to using diatoms or diatomaceous earth in the methods and compositions of this disclosure is intended to refer to using diatoms as a whole, and to using any individual structural features of the diatom. For example, when disclosing a composite that comprises a diatom, and unless otherwise stated, Applicant(s) intend to disclose individually each structural element of the diatom, such as the frustule, the frustule's two overlapping sections known as valves, in which the slightly larger upper valve is termed the epitheca, which overlaps the lower valve, the hypotheca. The join between the two valves is supported by bands of silica (girdle bands) that hold the two valves together. The frustule contains many pores and slits and structural elements that provide the nanostructured features that are thought to be useful in this disclosure. These structures are called aerolae that house the nanomatrices.

The term exemplary is intended to mean by way of example, and is not intended to designate a preferred embodiment.

### Hydrogen Storage System

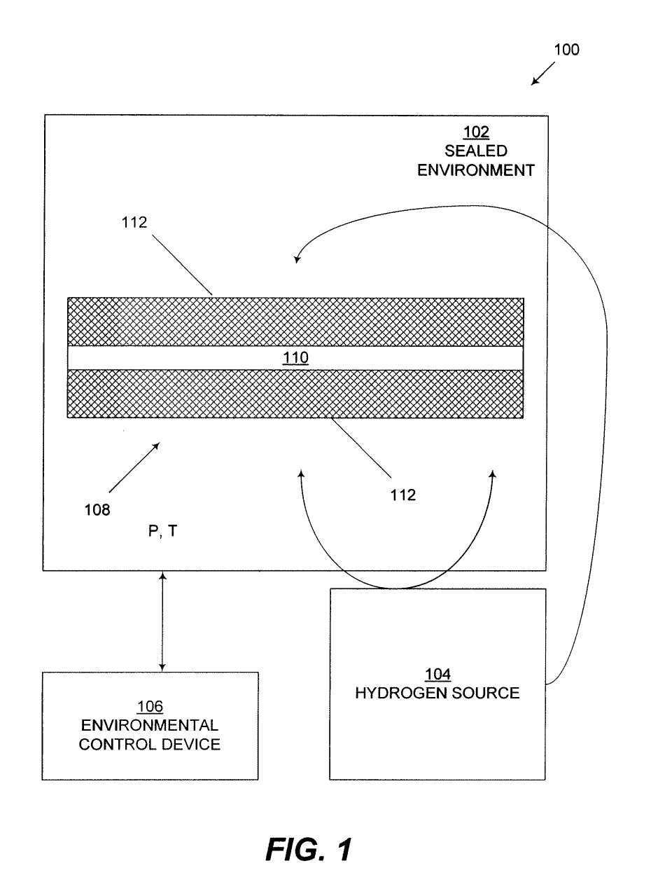

An exemplary system according to one disclosed embodiment is illustrated in FIG. 1. The system 100 shown in FIG. 1, also known as a diatom hydrogen storage system, can include a sealed environment 102, at least one hydrogen source 104, and at least one environmental control device 106. One suitable sealed environment can be a pressure vessel or similar substantially airtight environment. The sealed environment 102 is generally suitable to contain an apparatus 108, also known as a diatom hydrogen storage apparatus, in accordance with an embodiment of this disclosure. In this embodiment, and as further described below, the apparatus 108 can comprise at least one substrate 110 with diatom material and a nanostructure assembly 112. Generally, the nanostructure assembly 112 is capable of capturing and storing a predefined quantity of hydrogen. In certain embodiments, the nanostructure assembly 112 can be chemically and/or physically altered to capture and store additional quantities of hydrogen. In any instance, when the substrate 110 is exposed to hydrogen from a hydrogen source 104, the nanostructure assembly 112 can capture and store some or all of the hydrogen. In the diatom hydrogen storage system 100 shown in FIG. 1, the nanostructure assembly 112 can comprise, consist of, or consist essentially of any of the catalytic compositions disclosed herein, including, for example, at least one modified or unmodified nanostructured biomaterial in contact with at least one hydride source. In other disclosed embodiments, the apparatus 108 can comprise at least one nanostructure assembly 112, such as for example, at least one modified or unmodified nanostructured biomaterial in contact with at least one hydride source, in the absence of a substrate 110.

To facilitate the hydrogen storage capacity of the nanostructure assembly 112, the system 100 can be exposed to certain predefined conditions, such as a range of pressures P and temperatures T, during the exposure of the nanostructure assembly 112 to the hydrogen source 104. In the embodiment shown, an environmental control system 106 can modify the environmental conditions within the sealed environment 102 based in part on the initial startup conditions of the system 100, conditions during hydrogen storage, conditions after hydrogen storage, or any combination thereof. The environmental control system 106 can include various heating and/or pressure control components including, but not limited to, an external heating source, a pressurization or vacuum generation device, any number of pressure and/or temperature sensors, a feedback control device, a timer, or any combination thereof. In certain embodiments, the environmental control system 106 can facilitate increasing or decreasing the amount of excess hydrogen within the sealed environment 102 after storage or release of hydrogen from the nanostructure assembly 112.

In various embodiments, an environmental control device such as 106 can introduce one or more replacement or emplacement metals, which are used to modify the silica diatom material, into the sealed environment 102. By selectively controlling one or more environmental conditions within the sealed environment 102, the replacement or emplacement metals can either replace silica or fixate with silica in the substrate 110 and/or nanostructure assembly 112, thus improving the hydrogen storage capacity of the apparatus 108. In these environments, the environmental conditions can include, but are not limited to, pressure, temperature, solution concentration, and exposure time to replacement or emplacement metals.

In at least one embodiment, an environmental control device such as 106 is operable to release at least a portion of the stored hydrogen from the substrate 110 and/or nanostructure assembly 112. For example, the environmental control device such as 106 can selectively control one or more environmental conditions, such as pressure and temperature, to facilitate release some or all of the stored hydrogen from the substrate 110 and/or nanostructure assembly 112. As needed, an environmental control device such as 106 can be operable to re-expose the substrate 110 and/or nanostructure assembly 112 to hydrogen; and store at least a portion of the hydrogen in the substrate 110 and/or nanostructure assembly 112.

In other aspects and at least one embodiment, hydrogen can be stored in an apparatus such as 108 and/or sealed environment such as 102 for certain durations of time with our without increased temperature, increased pressure, or a combination of each variable of temperature and pressure.

It will be appreciated that components of the system 100 and apparatus 108 shown in and described with respect to FIG. 1 are provided by way of example only and is not shown to scale. Numerous other operating environments, system architectures, and system, device, or apparatus configurations are possible. Accordingly, embodiments of the disclosure should not be construed as being limited to any particular operating environment, system architecture, or system, device, or apparatus configuration.

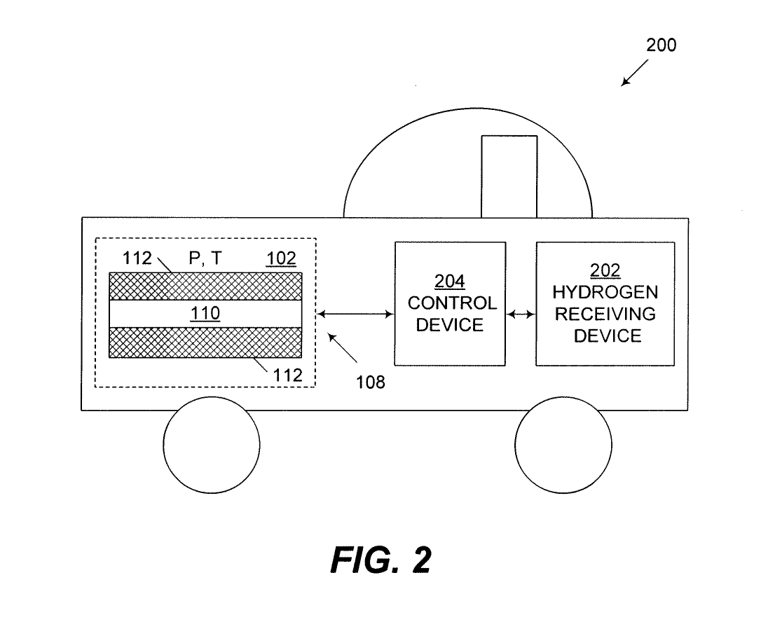

After the apparatus 108 has stored a certain quantity of hydrogen, the apparatus 108 and/or sealed environment can be utilized in any number of industrial, commercial, engineering and/or research applications. In this aspect for example, and as shown in FIG. 2, the apparatus 108 can be utilized as a hydrogen power source for a hydrogen-powered device 200 such as, but not limited to, a hydrogen-powered vehicle, a hydrogen-powered appliance, a hydrogen-powered fuel cell, other hydrogen-powered electricity-generating devices or stations, and any number of other applications for energy or power generation. In such embodiments, the apparatus 108 may be contained within the sealed environment 102 as shown in FIG. 2, or in other embodiments, may not be contained within the sealed environment 102. In the embodiment of FIG. 2, the hydrogen-powered device 200 can include a hydrogen receiving device 202, which upon receipt of hydrogen can generate suitable power for operating the hydrogen-powered device 200, such as suitable power to drive certain components or functionality of the hydrogen-powered device 200. In certain embodiments, such as shown in FIG. 2, the hydrogen receiving device 202 can include a control device 204 to provide suitable conditions for extracting or otherwise releasing stored hydrogen from the apparatus 108. For example, the control device 204 can provide a suitable range of pressures and temperatures within the sealed environment 102 for releasing stored hydrogen from the apparatus 108.

In any instance, after some or all of the stored hydrogen has been extracted, desorbed, or released from the apparatus 108, the apparatus 108 can be “recharged” with additional hydrogen. In certain embodiments, the apparatus can be removed from the hydrogen-powered device 200, or in other embodiments, the apparatus can remain on board or otherwise mounted to the hydrogen-powered device 200. In any instance, the apparatus 108 can be maintained within a sealed environment such as 102, and at least one hydrogen source such as 104 in FIG. 1 can provide hydrogen to the apparatus 108 for capture and storage. In this manner, the apparatus 108 can be used and recharged multiple times for storing and releasing a supply of hydrogen for use in any number of industrial, commercial and/or research applications. In certain embodiments, the apparatus 108, or diatom hydrogen storage apparatus, is capable of recycling hydrogen. That is, the apparatus can be charged with hydrogen, and discharged into a hydrogen accepting device such as an internal combustion engine or a fuel cell device, and subsequently recharged with hydrogen.

One will appreciate that components of the system 200 and apparatus 108 shown in and described with respect to FIG. 2 are provided by way of example only and are not shown to scale. Numerous other operating environments, system architectures, and system, device, or apparatus configurations are possible. Accordingly, embodiments of the disclosure should not be construed as being limited to any particular operating environment, system architecture, or system, device, or apparatus configuration.

### Nanostructured Biomaterials and Assemblies for Hydrogen Storage

In some aspects and embodiments of the disclosure, a range of various naturally occurring nanostructures can be utilized to facilitate hydrogen storage. The ability to control the synthesis and the assembly of particular nanostructured biomaterials into suitable nanostructured assemblies is at least one factor in selecting for use certain structures for the storage of hydrogen.

One example of a suitable nanostructure in accordance with an embodiment of this disclosure is the use of naturally occurring biological templates embodied in algae called diatoms. Taxonomically classified within general alga, diatoms can be found in both saline and freshwater aquatic ecosystems and play a role in the regulation and cycling of silica in such environments while providing an abundant food source for aquatic animals. Generally, diatoms are naturally occurring and can be genetically controlled and replicated under certain defined conditions. As used herein, the term “naturally occurring” can be construed to distinguish from man-made devices or constructs, and refers to the initial creation of a particular device or construct by nature. For example, various embodiments can utilize diatoms and associated nanostructure assemblies which are naturally occurring, wherein such diatoms and nanostructure assemblies can subsequently be altered, modified, or otherwise changed to facilitate the storage of hydrogen. In any instance, regardless of whether the diatoms and nanostructures are ultimately altered, modified, or changed from their original natural state, such diatoms and nanostructures are referred to as naturally occurring.

Diatoms can also be found in diatomaceous earth, which is the geological deposit of fossilized silica shells of diatoms. Diatoms may be present naturally in geological diatomite deposits in the United States, including but not limited to regions in Oregon, Nevada, Washington, Florida, California, and New Jersey. Commercially available diatom material can be mined from such deposits, and may be available under the names DE, TSS, diatomite, diahydro, kieselguhr, kieselgur and/or Celite. For example, one commercial source of diatom material is in Lompoc, Calif.

For clarification, diatomaceous earth is nonliving and since life comes only from life, the diatomaceous earth is not a sufficient inoculum for culturing. In at least one embodiment, one or more diatoms can be grown and cultivated in an aquiculture or microbiological environment, such as a predefined culture. Diatoms are generally unicellular photosynthetic algae with enormous diversity of patterns in their silica structures at the nano- to micronscale. For example, one process for growing and cultivating suitable diatoms in accordance with an embodiment is as follows. Initially, a medium can be prepared on a tube-by-tube basis, using approximately 15 mL glass tubes, stoppered with rubber-lined screw caps. Next, a diatomic material, such as saline, freshwater or soil containing Bacillariophytes can be mixed with a liquid, such as distilled water and/or seawater. An example mixture or media can include about 1 cc of saline, freshwater or soil (CR1 soil), about 12 ml of distilled water (dH₂O), and about 1 drop of pasteurized seawater.

Once the soil and liquid are mixed, the mixture or media is processed by pasteurization and/or autoclaving for, by way of example, up to 6 hours. For instance, an autoclaved mixture or media is processed for about 15 minutes, since transfer material typically contains organics and/or bacteria needed for algal growth. In a pasteurization process, tubes with a mixture or media can be brought to just under boiling temperature at about 98° C., and held at that temperature for about 2 hours. The tubes with the mixture or media are cooled to about room temperature for about 20-24 hours. Either of these processes can repeated for about three successive days. In certain embodiments, the mixture or media (pasteurized and/or autoclaved) is allowed to gas-equilibrate for about 2 days prior to use.

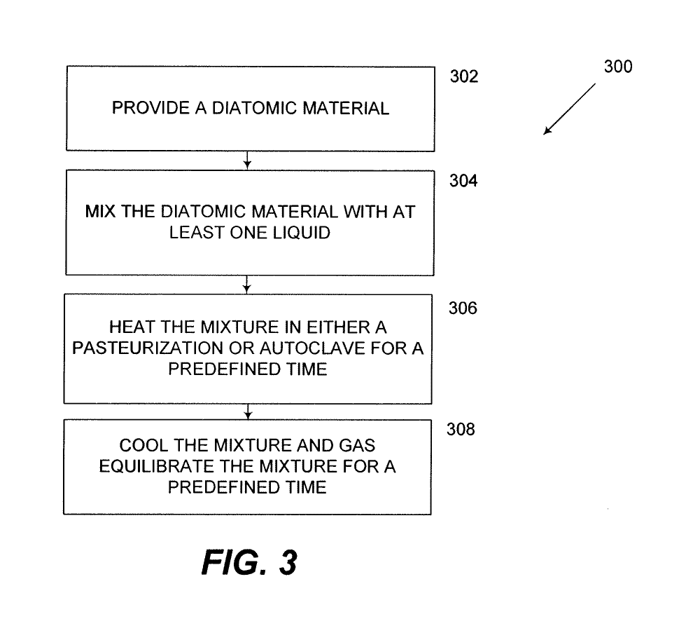

An exemplary process for preparing diatoms in a culture is shown as 300 in FIG. 3.

The process 300 begins at block 302, in which a diatomic material is provided. For example, in the embodiment shown in FIG. 3, a suitable diatomic material to be provided can contain Bacillariophytes.

Block 302 is followed by block 304, in which the diatomic material is mixed with at least one liquid. For example, in the embodiment shown, the liquid can be a mixture of distilled water and/or pasteurized seawater.

Block 304 is followed by block 306, in which the mixture is heated for a predefined time. For example, the mixture can be heated by a pasteurization and/or autoclaving process for up to 6 hours. For example, an autoclave process can process the mixture for about 15 minutes. In a pasteurization process, the mixture can be brought to just under boiling temperature at about 98° C., and held at that temperature for about 2 hours.

Block 306 can be followed by block 308, in which the mixture is cooled and gas equilibrated prior to use of the diatoms. For example, the mixture can be cooled to about room temperature for about 20-24 hours. In certain embodiments, either or both pasteurization and autoclaving processes can repeated for about three successive days. In certain other embodiments, the mixture can be gas-equilibrated for about 2 days prior to use.

In this exemplary process, the process 300 ends at block 308.

After selected diatoms are grown in culture to a desired density using the process 300 in FIG. 3, the diatoms can be harvested by centrifugation and processed by filtration as previously described herein. The processed diatoms can then be used in a replacement process wherein the silica in the diatoms can be replaced by any number of metals, or in an emplacement process wherein any number of metals can be fixated to the silica in the diatoms. In either instance, the diatoms can be used in hydrogen storage according to certain embodiments as described herein.

The example elements of FIG. 3 are shown by way of example, and other process embodiments can have fewer or greater numbers of elements, and such elements can be arranged in alternative configurations in accordance with other embodiments of the disclosure.

In this manner, diatoms can be a renewable resource when grown and cultivated in an aquiculture or microbiological environment, such as a predefined culture.

Particular examples of suitable diatoms which can be grown and cultivated in an aquiculture or microbiological environment, such as a predefined culture, are the Bacillariophytes which contain many types and species of diatoms that can be used in accordance with various embodiments. In any instance, each suitable diatom can have various patterns of nanopores that provide for high surface to volume ratios. In one instance, each diatom of a specific genus may contain as many as about 2,500 nanostructures (areolae) within a frustule. Each areola within the frustule may contain approximately 8,000 nm³ and 2.00×10⁷ cubic nanometers for each diatom. Diatom cultures that contain about 10⁶ algae/ml can have a reactive surface area of approximately 2.00×10¹³ cubic nanometers.

Reference to nanostructured biomaterials or assemblies is intended to reflect that diatoms are the prototypical nanostructured biomaterial, and this description as nanostructured is further intended to reflect the particular scale of the structural features such as pores and channels found in diatoms, whether in natural form or modified as disclosed herein. Thus, even if the patterns in their silica structures extend beyond nanometer scale to encompass micronscale (or “microscale”) structural features, for convenience, such materials are referred to herein as nanostructured biomaterials. For example, pore sizes of the nanostructured biomaterials that are useful can be from less than 1 to 3000 nm, from 2 to 2500 nm, from 5 to 2000 nm, from 10 to 1500 nm, from 25 to 1000 nm, from 50 to 900 nm, or from 75 to 800 nm, from 100 to 700 nm, from 125 to 600 nm, or from 150 to 500 nm. In another aspect, for example, the pore sizes of the nanostructured biomaterials that are useful can be less than 1 nm, about 10 nm, about 25 nm, about 50 nm, about 75 nm, about 100 nm, about 200 nm, about 300 nm, about 400 nm, about 500 nm, about 600 nm, about 700 nm, about 800 nm, about 900 nm, about 1000 nm, about 1100 nm, about 1200 nm, about 1300 nm, about 1400 nm, about 1500 nm, about 1600 nm, about 1700 nm, about 1800 nm, about 1900 nm, about 2000 nm, about 2500 nm, or about 3000 nm. Typically, nanometer scale (nanoscale) features can be from about 1 to 1000 nm, from about 50 nm to about 750 nm, or from about 100 nm to about 500 nm.

Various examples of suitable diatoms having reproducible structures that exist in relatively intricate 3-D mineralized constructs are shown in certain images of silica-based microshells (frustules) of various diatom species described by F. E. Round, R. M. Crawford, and D. G. Mann, “The Diatoms: Biology & Morphology of the Genera”, University Press (1990).

In some instances, living species of diatoms are genetically regulated to reproduce themselves in intricate frustule structures, which contain numerous regularly spaced and sized nanostructures. In other instances, living diatoms may be cultivated under certain conditions that allow continuous and rapid replication, for instance, relatively large numbers of diatoms can be grown in culture. When diatoms replicate, they assemble into large biofilm structures with nanoscale templates. In any instance, the synthesis and the assembly of one or more diatoms into suitable nanostructure assemblies can be facilitated.

Other suitable diatoms, diatomic materials, and nanostructure assemblies in accordance with the various embodiments disclosed herein can exist and will be apparent from the above.

### Preparing Suitable Nanostructure Assemblies for Hydrogen Storage and Catalytic Activity

Generally, selected diatoms can be prepared, modified, or otherwise processed to provide nanostructures or diatom assemblies capable of storing hydrogen by sorption and desorption of hydrogen in accordance with various embodiments of the disclosure. Similarly, selected diatoms can be prepared, modified, amended, or otherwise processed to provide nanostructures or diatom assemblies capable of catalytic activity, for example, able to catalyze the sorption and desorption of hydrogen in the disclosed composites in accordance with various embodiments. By amending the subject biomatrices with metals, catalytic activity can be imparted to the modified biomatrices such that a wide range of applications are possible. For example, catalytic activity for reversible hydrogen sorption and desorption is introduced to the biomatrices. These metal-modified biomatrices may also exhibit utility in catalytic converters at temperatures substantially lower than the conventional 500° C.-600° C. that traditionally has been necessary for their efficient operation. For example, it is expected that these metal-modified biomatrices have the ability to catalytically remove pollutants such as oxides of sulfur, nitrogen, and the like, from exhaust streams at temperatures as low as about 200° C. The advantages of such metal-modified biomatrices in these applications are both practical, such as their ready availability and comparatively low cost, and technical, such as their enhanced surface area and the ability to tune their reactivity modifying the biologically-tailored diatoms.

Suitable preparation processes in accordance with this disclosure are described below. Some disclosed embodiments include the use of a diatom nanostructure without chemical or physical alterations. Other embodiments relate to modifying a diatom nanostructure with certain chemical and/or physical alterations to capture hydrogen and/or catalyze the reversible hydrogen storage process.

### Silica Modification Processes

One process in accordance with an embodiment of this disclosure involves the partial or substantially complete replacement of silicon (Si) with a metal, such as titanium (Ti), within the diatom structure. This embodiment results in a plurality of diatoms with catalytic-type nanostructures, wherein the original nanopore-type structure of some, all, or substantially all of the diatoms remains intact. These new nanostructures can retain a similar integrity and construct of the original diatom structures. Essentially, the process can result in chemical conversion of certain components within some or all of the silica atoms of the diatom frustule which results in nanostructures capable of capturing and storing hydrogen. In this manner, the nanostructures can mimic the original diatom structure but provide unexpected increased capacity to capture and store hydrogen by way of the available surface area and open 3-D pore configurations of the nanostructures. In other embodiments, diatom silica can be replaced by other materials capable of capturing and storing hydrogen, as well as facilitating catalytic activity such as at least one other transition metal such as zirconium, vanadium, or hafnium, at least one alkali metal, at least one alkaline earth metal, at least one lanthanide, at least one actinide, and/or at least one main group metal to provide a porous hydrogen storage medium and/or catalysts for use in combination with hydrides.

In this embodiment, for example, the process can begin by obtaining suitable diatoms, such as commercially available diatomaceous earth containing numerous and diverse diatom species. In another embodiment, suitable diatoms can be replicated, for instance, by cultivating diatoms under certain defined conditions that allow continuous and rapid replication and an accumulation of diatom biomass. In any instance, suitable diatoms can be pre-assembled in frustral-type structures or other similar structures having nanostructure assemblies. The term “frustule” as used herein refers to the outer shell (the inner surfaces are also made of silica oxide) of the diatom which is made up of silica oxide.

The raw diatomaceous earth can be initially processed to remove any foreign material and to increase the concentration of diatoms within the processed or filtered material. The filtered material containing diatoms can be further processed to obtain diatoms of a predefined size. For example, a mill can be used to filter and grind suitable diatoms to a predefined size such as less than about 100 microns as separated by differential filtration. In another example, suitable diatoms can be processed by a continuous flow centrifugation device at about 7,000 rpm using distilled water and saline solutions at about 7.2 pH. After such processing, the diatoms or diatomaceous material can be concentrated by filtration and air dried to form a powder-type substance. Other milling, centrifugation, filtration, drying, or similar processing devices or techniques can be used in accordance with other embodiments of the invention. Excess interstitial water can be removed by heating the diatom composite to greater than 350° C.

In any instance, the processed diatoms can be introduced into a sealed atmosphere, for example, a sealed nitrogen or inert atmosphere. Within the sealed atmosphere and at elevated temperatures, at least one replacement metal can be added to the mixture. Under these conditions, the replacement metal can replace by substitution chemistry some or all of the silica within the diatoms. Example suitable replacement metals can include, but are not limited to, alkali metals, alkaline earth metals, transition metals, lanthanides, actinides, and/or main group metals. For example, suitable replacement metals can include, but are not limited to, titanium, vanadium, zirconium, hafnium, chromium, iron, cobalt, rhodium, palladium, platinum aluminum, boron, and the like, including combinations thereof. Moreover, any metals that can be used in catalytic converters to impart catalytic behavior can be employed to modify or amend the biomatrices disclosed herein.

In other embodiments, combinations of metals can be added to the filtered and processed diatoms in a sealed atmosphere, and various replacement metals can replace some or all of the silica within the diatoms. In addition, various time, temperature, pressure ratios can be implemented to achieve varying replacement metal / silica replacement results.

In one aspect, one example of preparing these modified nanostructured biomaterials, is effected by the use of a metal fluoride, which can undergo a metathesis reaction with the silica to form a new nanostructured metal oxide, typically releasing SiF₄ as a by-product. By way of example, titanium tetrafluoride (TiF₄) can be added to filtered and/or milled diatoms within a sealed atmosphere inside of a titanium pressure vessel. The vessel can be heated to approximately 250 degrees Centigrade to initiate an exothermic reaction between the diatoms and titanium tetrafluoride, wherein the temperature increases to about 300 degrees Centigrade. After stabilization of the reaction and temperature, the vessel can be maintained at about 350 degrees Centigrade for about 2 hours and then cooled to room temperature. Upon cooling, oxygen or air is introduced to the vessel at about 300 cubic centimeters per minute for approximately 2 hours at about 350 degrees Centigrade to remove or otherwise sublimate excess titanium tetrafluoride. In other embodiments, any number of environmental conditions within the sealed environment can be controlled including, but not limited to, pressure, temperature, excess moisture, and any combination thereof. In this manner, some or all of the titanium tetraflouride can replace some or all of the silica within the diatoms. Once cooled to room temperature, the modified diatom nanostructure is suitable for hydrogen storage or catalytic activity.

In another embodiment, titanium (Ti) metal powder can be added to filtered and/or milled diatoms within a sealed atmosphere. The mixture can be heated to approximately 600 degrees Centigrade for about 2 hours. In this manner, some or all of the titanium can replace some or all of the silica within the diatoms. That is, a reactive conversion of 3-D SiO₂ nanoparticle-based diatom frustules into nanocrystalline TiO₂ (anatase) via the use of a metathetic gas/silica displacement reaction can be implemented. The displacement structures can mimic the original diatom structural pattern including its nanopores but with the replacement of silica by titanium. Once cooled to room temperature, the modified diatom nanostructure is suitable for hydrogen storage or catalytic activity. By using this embodiment of SiO₂ replacement, the replacement process can be carried out to replace substantially all, or only a portion, of the silicon with titanium. For example, from about 5% to about 100% of the silicon can be replaced with titanium, if so desired.

In another embodiment, a particular silicon replacement process described in Unocic, et al., “Anatase assemblies from algae: coupling biological self-assembly of 3-D nanoparticle structures with synthetic reaction chemistry” (Unocic, R. R.; Zalar, F. M.; Sarosi, P. M.; Cai, Y.; Sandhage, K. H. Chemical Communications 2004, 796-797), can be utilized to modify a diatom nanostructure suitable for hydrogen storage.

It will be appreciated that the disclosed methods are applicable to a wide range of metals and atoms that can be used to replace silica in the nanostructured biomaterial, or otherwise modify the nanostructured biomaterial, which provides a large number of suitable materials that can be used according to this disclosure. In one aspect, for example, the disclosed methods can be employed to modify the nanostructured biomaterial such as diatoms, to form a nanostructured biomaterial comprising or selected from titania, alumina, zirconia, magnesia, boria, silica-alumina, titania-alumina, silica-titania, silica-zirconia, silica-magnesia, silica-alumina-titania, silica-alumina-zirconia, boria-alumina, tungstated zirconia, alumina-zirconia, alumina-ceria, yttria, lanthana, ceria, neodymia, samaria, europia, gadolinia, praseodymia, silica-thoria, silica-berylia, silica-alumina-thoria, aluminophosphates, mixed oxides thereof, and any combinations thereof.

It also will be appreciated that the disclosed methods are applicable to a wide range of metals and atoms that can be used to replace silica in diatomaceous earth to form a suitable modified nanostructured biomaterial. In this aspect, for example, the at least one nanostructured biomaterial can be selected from silica diatomaceous earth, titania diatomaceous earth, zirconia diatomaceous earth, alumina diatomaceous earth, boria diatomaceous earth, yttria diatomaceous earth, lanthana diatomaceous earth, ceria diatomaceous earth, any mixed oxide diatomaceous earth thereof, or any combination thereof.

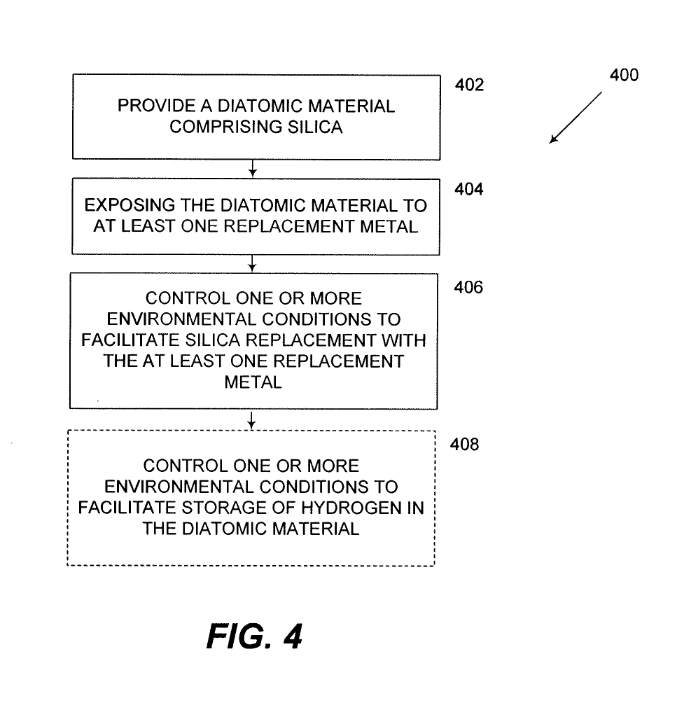

Thus, in accordance with the various other embodiments, the use of other metals than titanium, titanium tetrafluoride can be employed in the silica replacement process to prepare a suitable modified diatom nanostructure to store and release hydrogen. Thus, as shown in FIG. 4, an example process 400 for preparing a suitable diatom nanostructure assembly, wherein silica is replaced in one or more diatoms is shown as process 400. The method 400 can be implemented by various system components shown in FIG. 1.

The process 400 begins at block 402, in which a diatomaceous material is provided. For example, in the embodiment shown in FIG. 4, a suitable diatomic material to be provided can be Bacillariophytes. Other suitable types of diatomaceous material can be utilized in accordance with embodiments of the invention.

Block 402 is followed by block 404, in which the diatomic material is exposed to at least one replacement metal. For example, in the embodiment shown in FIG. 4, suitable replacement metals can include, but are not limited to, alkali metals, alkaline earth metals, transition metals, lanthanides, actinides, and/or main group metals, including combinations thereof.

Block 404 is followed by block 406, in which one or more environmental conditions are controlled to facilitate silica replacement with the at least one replacement metal. For example, in the embodiment shown in FIG. 4, any number of environmental conditions within the sealed environment can be controlled including, but not limited to, pressure, temperature, excess moisture, and any combination thereof. In this manner, the replacement process can be carried out to replace some or substantially all of the silica with at least one replacement metal.

In one aspect of one embodiment, such as optional block 408, one or more environmental conditions are controlled to facilitate storing hydrogen in the diatomic material. For example, in the embodiment shown in FIG. 4, any number of environmental conditions within the sealed environment can be controlled including, but not limited to, pressure, temperature and any combination thereof. In this manner, a predefined quantity of hydrogen can be stored in the diatomic material.

The process 400 ends at block 408.

The example elements of FIG. 4 are shown by way of example, and other process embodiments can have fewer or greater numbers of elements, and such elements can be arranged in alternative configurations in accordance with other embodiments of this disclosure.

### Solution Emplacement Pathway

In another embodiment, solution emplacement can be used to modify a nanostructured biomaterial. While not intending to be bound by theory, it is thought that solution emplacement provides generally a method for attaching or otherwise depositing the one or more metals, metal-containing moiety, or metal complex or cluster to the silica in the diatom nanostructure. However, depending upon the conditions and the precursors, this method may provide some substitution of the silicon with the modifying metal, or a combination of replacement with deposition. Generally, solution emplacement can be implemented by the exposure of one or more solution phase metals to a selected substrate, followed by a fixation process, usually by heating. This process appears to cause the doping of one or more metals to the selected substrate. For example, one or more suitable alkali metals, alkaline earth metals, transition metals, lanthanides, actinides, and/or main group metals, such as palladium (Pd), lithium (Li), iron (Fe), cobalt (Co), copper (Cu), platinum (Pt), magnesium (Mg), and the like, can be used to modify the nanostructured biomaterial by, for example, by attaching or depositing the metal(s). In this manner, for example, the nanopore structure of the diatoms can be filled with one or more reactive-type metals through a solution chemistry emplacement process. This process can minimize or otherwise prevent merely covering the surface of the diatom nanostructure or diatom assembly with one or more metals, which may diminish the overall hydrogen reactivity and storage capacity of the diatom nanostructure assembly. Instead, the process can provide greater metal coverage within the diatom nanostructure or diatom assembly to facilitate increased hydrogen storage by the diatom nanostructure.

At least two solution emplacement-type methodologies can be used in accordance with an embodiment of the disclosure. In one embodiment, relatively long diffusion pathways in the associated areolae structure of a diatom nanostructure or diatom assembly can be utilized. A soluble salt can be added to a solution mixture of the diatom nanostructure or diatom assembly, and allowed to equilibrate for a relatively long time period. The diatom nanostructure or diatom assembly can be separated from the soluble salt solution, washed, and in some instances, fixed by thermal treatment using deionized water. In other instances, remaining solution on the diatom nanostructure or diatom assembly can be removed by way of evaporation, which can be assisted by at least one methylene compound, such as methylene chloride, acetone, or other compounds with a relatively high vapor pressure. Because of the relatively long diffusion pathways within the areolae, the outer diatom nanostructure or diatom assembly surface can be washed of some or all metals or metal species without reducing metal concentrations within the areolae.

In another aspect, one or more relatively large organic blocking molecules, such as polyethylene glycol (PEG), can be used to minimize or otherwise prevent outer surface fixation of metals to the diatom assembly. In some instances, suitable PEG can be purchased commercially in a wide range of molecular weights or sizes. The PEG weight or size can be varied to select an optimal size to permit suitable metal binding/sorption to the outer surface of the diatom assembly while allowing access of the soluble salt solution to the associated areolae structures of the diatom assembly.

In yet another aspect and in various embodiments, a solution emplacement process using colloidal-type metals can be implemented. In one example, an approach using a combination of silica beads and noble metals (e.g., Au, Pt/Pd, and mesoporous silica and quantum dots of ZnS/CdS) may be used. For the silica beads, a thiol functionalized polydimethyl siloxane (PDMS) surface reaction can be initiated, followed by reaction of small nanoparticles that selectively react at a selected site surface.

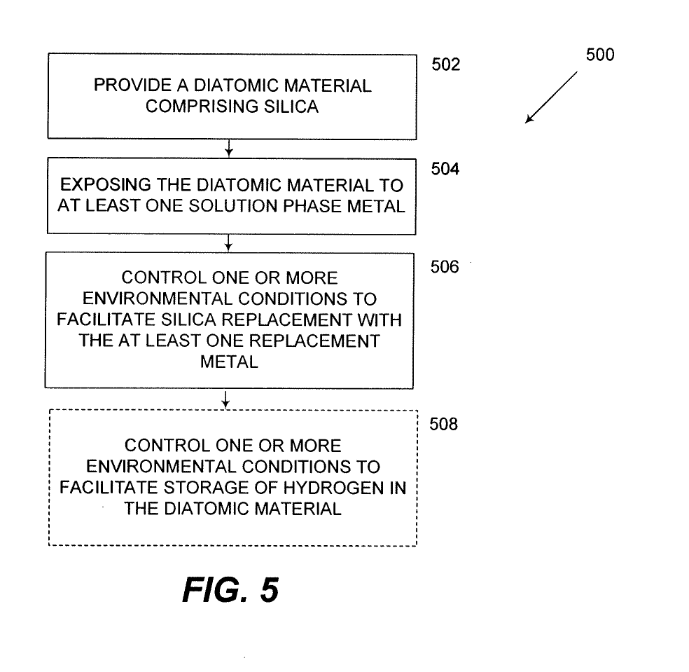

Thus, as illustrated in FIG. 5, an example process 500 for preparing a suitable diatom nanostructure assembly, wherein at least one metal is fixed or associated to silica in one or more diatoms is shown as process 500. The method 500 can be implemented by various system components shown in FIG. 1. The process 500 begins at block 502, in which a diatomic material is provided. For example, in the embodiment shown in FIG. 5, a suitable diatomic material to be provided can be a Bacillariophytes or other suitable types of diatomic material can be utilized in accordance with embodiments of the invention.

Block 502 is followed by block 504, in which the diatomic material is exposed to at least one solution phase metal. For example, in the embodiment shown in FIG. 5, suitable solution phase metals can include, but are not limited to, mid-to-late transition metals such as iron (Fe) or palladium (Pd), alkali metals, such as lithium (Li), main group metals, such as germanium (Ge), and any combination thereof.

Block 504 is followed by block 506, in which one or more environmental conditions are controlled to facilitate fixation of the at least one metal with the silica in the diatomic material. For example, in the embodiment shown in FIG. 5, any number of environmental conditions within the sealed environment can be controlled including, but not limited to, pressure, temperature, excess moisture, and any combination thereof. In this manner, the emplacement process can be carried out to fixate some or substantially all of the at least one metal to the silica in the diatomic material.

In one aspect of one embodiment, such as optional block 508, one or more environmental conditions are controlled to facilitate storing hydrogen in the diatomic material. For example, in the embodiment shown in FIG. 4, any number of environmental conditions within the sealed environment can be controlled including, but not limited to, pressure, temperature and any combination thereof. In this manner, a predefined quantity of hydrogen can be stored in the diatomic material.

The process 500 ends at block 508.

The example elements of FIG. 5 are shown by way of example, and other process embodiments can have fewer or greater numbers of elements, and such elements can be arranged in alternative configurations in accordance with other embodiments of the invention.

### Hydride Sources

According to various aspects of this disclosure, there is provided a catalytic composition comprising at least one modified or unmodified nanostructured biomaterial in contact with at least one hydride source. The hydride source can be a complex hydride source, a simple hydride source, or a combination thereof. The contact product of the nanostructured biomaterial and hydride source is referred to as a composite, a nanostructured composite, and similar terms.

By way of example, and not as a limitation, a nanostructured composite can be prepared as follows, using a 20 wt % NaAlH₄-diatomaceous earth composite (20 wt % diatomaceous earth in the composite and 80 wt % NaAlH₄ in the composite) as an example, A solution of the hydride source NaAlH₄ can be prepared in THF (10 ml, 1M), and this mixture can be added to a sample of previously baked diatoms (1.1 g) in a single-neck flask under an inert atmosphere. This mixture forms a suspension, which can be stirred at, for example, room temperature, for a period of time such as 1-2 minutes, 20 minutes, an hour, several hours, overnight, or several days. After contacting in this manner, the residual solvent is typically removed under reduced pressure, and the solid composite sample collected and dried under vacuum.

In one aspect, a wide range of complex hydrides or “complex hydride sources” can be utilized in the compositions and methods of this disclosure. By way of example and not as a limitation, the at least one hydride source can comprise or can be selected from a compound having the formula:

[M^{A}]⁺ⁿₓ[M^{B}H_{y}]^{-m}_{z}, wherein:

M^{A} is a one or more metals selected from at least one Group 1-12 metal, a lanthanide, or an actinide,

+n is the total formal charge on the combined one or more metals;

M^{B} is a Group 13 element,

y is the number of hydride ligands associated with M^{B};

−m is the formal charge on the hydride complex, wherein m=y−3;

and x and z are numbers corresponding to the stoichiometry in the compound, wherein x×n=z×m.

It is not necessary that the hydride include a binary hydride complex anion, that is, ligands other than hydride can occur in the hydride complex. Moreover, more than one metal can occur in the complex, either as the counter ion metal, or as the metal to which a hydride complexes. For example and not as a limitation, the at least one hydride source can comprise or can be selected from a compound having the formula:

[M^{A}]⁺ⁿₓ[M^{B}H_{y}X_{q}]^{-m}_{z}, wherein:

M^{A} is a one or more metals selected from at least one Group 1-12 metal, a lanthanide, or an actinide,

+n is the total formal charge on the combined one or more metals;

M^{B} is a Group 13 element,

y is the number of hydride ligands associated with M^{B};

X, in each occurrence, is selected from halide, tetrahydridoborate, tetrahydrido-aluminate, C₁-C₁₂ alkyl, C₆-C₁₂ aryl, C₁-C₁₂ alkoxide, or C₆-C₁₂ aryl oxide;

q is the number of non-hydride ligands associated with M^{B};

−m is the formal charge on the hydride complex, wherein m=y+q−3;

and x and z are numbers corresponding to the stoichiometry in the compound, wherein x×n=z×m.

According to one aspect of this disclosure, the hydride source (or simply complex “hydride”) can comprise or can be selected from complex hydrides such as LiAlH₄, NaAlH₄, KAlH₄, RbAlH₄, CsAlH₄, LiBH₄, NaBH₄, KBH₄, RbBH₄, CsBH₄, NaGaH₄, KGaH₄, Al(BH₄)₃, LiAlH₂(BH₄)₂, Mg(BH₄)₂, Ti(BH₄)₃, Fe(BH₄)₃, Ca(BH₄)₂, Mg(AlH₄)₂, Ti(AlH₄)₄, Zr(BH₄)₃, K₂ReH₉, Mg(AlH₄)₂, Be(AlH₄)₂, Na₂LiAlH₆, CuAlH₄, Mn(AlH₄)₂, Fe(AlH₄)₂, AgAlH₄, Ga(AlH₄)₃, In(AlH₄)₃, Ce(AlH₄)₃, Sn(AlH₄)₄, NaCNBH₃, Li[BEt₃H], Li[AlEt₃H], and any combination thereof.

In a further aspect, various combinations of the nanostructured biomaterial and complex hydride source have been found to be particularly useful. For example, and not as a limitation, the at least one nanostructured biomaterial can comprise or can be selected from silica diatoms, titania diatoms, alumina diatoms, or zirconia diatoms, and the at least one complex hydride source can comprise or can be selected from LiAlH₄, NaAlH₄, KAlH₄, LiBH₄, NaBH₄, or KBH₄. In another example, the at least one nanostructured biomaterial can comprise or can be selected from nanostructured silica or nanostructured titania, and the at least one complex hydride source can comprise or can be selected from LiAlH₄, NaAlH₄, LiBH₄, or NaBH₄.

According to a further aspect, a salt or ionic compound such as such as LiH, NaH, CaH₂, and the like, which also may be referred to as “simple” or ionic hydride source, can also be used in the compositions and methods disclosed here. Thus, terms “simple” or ionic hydride source may be used to distinguish these compound from those complex hydride sources having a hydride-containing coordination anion. Suitable simple or ionic hydride sources include, but are not limited to, LiH, NaH, KH, RbH, CsH, CaH₂, MgH₂, SrH₂, BaH₂, ScH₂, YH₂, LaH₂, AcH₂, Ln^{A}H₂ (Ln^{A} is selected from Ce, Pr, Nd, Sm, Gd, Tb, Dy, Ho, Er, Tm, or Lu), YbH₂, CeH₃, PrH₃, NdH₃, LaH₃, YH₃, Ln^{B}H₃ (Ln^{B} is selected from Sm, Gd, Tb, Dy, Ho, Er, Tm, or Lu), YbH_{2.5}, TiH₂, ZrH₂, HfH₂, Th₄H₁₅, PaH₃, UH₃, VH, NbH, TaH, VH₂, NbH₂, CrH, CrH₂, NiH, PdH, ZnH₂, CdH₂, HgH₂, BeH₂, AlH₃, GaH_{x ca. 3}, and the like, including any combination thereof.

### Hydrogen Placement, Storage, and Replacement

After composite formation using the nanostructured biomaterials and the hydride sources disclosed herein, the composite may be considered to contain a hydrogenated material in the form of the hydride source. Therefore, composites containing a hydride source typically can be subjected to a temperature programmed desorption (TPD), followed by a hydrogen resorption process, with this cycle repeated any number of times, and thereby function as a catalytic hydrogen storage composition or medium. Temperature programmed desorption (TPD) studies allow a determination of the unmodified or modified diatom's effect on the hydride.

In one aspect, and by way of example only, one method of conducting a series of temperature programmed desorption (TPD) is to subject the composite sample to a desorption step by ramping the temperature at about 2° C. per minute from about 30° C. to about 300° C., followed by maintaining the temperature at an isotherm at about 300° C. for 1-2 hours. The amount of hydrogen released can be measured during this desorption. Between each TPD measurement, hydrogen resorption can be carried out using a hydrogen overpressure applied to the composite sample, for example, from about 120 to about 130 bar at a particular temperature and for a particular time period. For example, subjecting the composite sample to a hydrogen overpressure of about 120 to about 130 bar for about 12 hours at about 150° C. to rehydrogenate the composite material is representative.

Also by way of example, after formation of the nanostructured biomaterial and hydride composite material, this composition can be exposed to hydrogen in certain predefined conditions to optimize or maximize hydrogen storage in the composition. In this aspect, for example, the composites can be exposed to hydrogen gas from sub-ambient pressures to relatively high pressures, for example, to about 10,000 psi of higher, and/or from elevated temperatures to cryogenic temperature conditions (extremely cold temperatures). It is also possible to use gas mixtures of hydrogen with another, typically inert gas, to adjust the conditions as desired. In this manner, hydrogen can be stored within the nanostructure or diatom assembly.

In a further aspect, to release the hydrogen from the nanostructured biomaterial and hydride composite material, certain temperatures and pressures can be implemented such that some, most, or substantially all of the hydrogen is released from, for instance, the metal hydride-nanostructured biomaterial composite. In other embodiments, electrical, chemical, thermal, or other types of reactions may be utilized such that some or all of the hydrogen is released from the composite.

Further aspects and embodiments of the invention can include rechargeable nanostructured biomaterial-hydride composite materials, which after at least one cycle of hydrogen placement and release, can be recharged to store and release hydrogen one or more additional times. In this manner, the hydrogen storage composite materials can be mounted to vehicles and other hydrogen use devices to provide a fuel or energy source, which can be recharged or renewed relatively quickly and easily, and multiple times.

In one example embodiment of the invention, a hydrogen storage module can be implemented with a hydrogen-powered vehicle. In one instance, a suitable hydrogen storage module can include one or more rechargeable nanostructure or diatom assemblies in combination with a metal hydride source as described herein and implementing some or all of the processes described above. When the hydrogen module is filled with hydrogen, the module can provide a supply of hydrogen to the vehicle. When needed, the vehicle or the module may implement any type of hydrogen release process, for example, by facilitating an appropriate temperature and pressure for the hydrogen to be released from the rechargeable composite material. When the hydrogen is depleted or nearly depleted from the assemblies, the hydrogen storage module can be replaced with another module that has been pre-filled with hydrogen, or the module can be recharged with hydrogen while the module is mounted to the vehicle. The use of such modulars for refills allows for ease of transport and provides a measure of safety for both the public and for the environment. Any number of similar or related embodiments and aspects of hydrogen storage can be envisioned and are encompassed by the present disclosure.

Hydrogen Storage Using Composites of Modified or Unmodified Diatoms with Hydrides

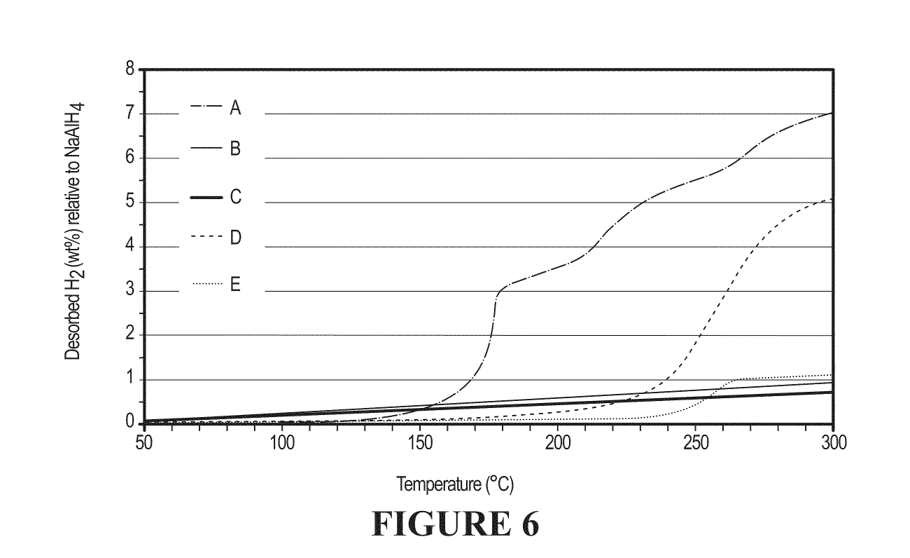

In order to understand the effect of diatom modifications on the hydrogen storage properties of composite materials, a composite containing an unmodified silica (SiO₂) diatom in combination with a hydride source was prepared. For example, a 20 wt % NaAlH₄-diatomaceous earth composite (20 wt % diatomaceous earth in the composite and 80 wt % NaAlH₄ in the composite) was prepared and examined for its reversible hydrogen storage behavior. The results of these TPD measurement cycles are illustrated in FIG. 6, which demonstrate an initial desorption activity, but low capacity for subsequent absorption in the silica diatom-hydride composite. While not intending to be theory-bound, certain observations can be made based on this TPD data of the 20 wt % NaAlH₄-diatomaceous earth composite from FIG. 6. Specifically, and again not intending to bound by theory, NaAlH₄ appears to completely dehydrogenate (dehydride) during the first TPD, releasing ca. 7 wt % H₂, which is close to the maximum amount theoretically possible (7.5 wt % H₂). The first TPD appears to have three delineated steps or stages of dehydrogenation, which is consistent with the three chemical reactions for progressive hydrogen release typically associated with NaAlH₄, illustrated here in Equations 1 to 3.

NaAlH₄→1/3Na₃AlH₆+2/3Al+H₂ 3.7 wt % H₂ (1)

Na₃AlH₆→3NaH+Al+3/2H₂ 5.6 wt % H₂ (2)

NaH→Na+1/2H₂ 7.5 wt % H₂ (3)

For at least this reason, the third step is noteworthy as Equation 3 typically requires elevated temperatures of at least about 500° C. when carried out on the native NaAlH₄ that is not associated with diatomaceous earth.

Moreover, attempts to rehydrogenate (or “rehydride”) the 20 wt % NaAlH₄-diatomaceous earth composite sample met with limited success, as subsequent TPD experiments yielded little appreciable hydrogen release. For example, the results for the 2^{nd} and 3^{rd} TPD experiments show only a minute calculated gradual increase in wt % H₂. While not intending to be bound by theory, it is likely that this minute increase in wt % H₂ can be attributed to, among other things: (1) impeded gas migration in the sample vial due to diatom packing and nominal thermal of gas present at the onset of the measurement; and/or (2) simple thermal expansion of the initial gas-volume. Diatomaceous earth samples throughout this study without hydrogen desorption exhibited virtually identical results. In conclusion, although initial catalytic activity is shown, this composite does not show appreciable reversible hydrogen sorption.

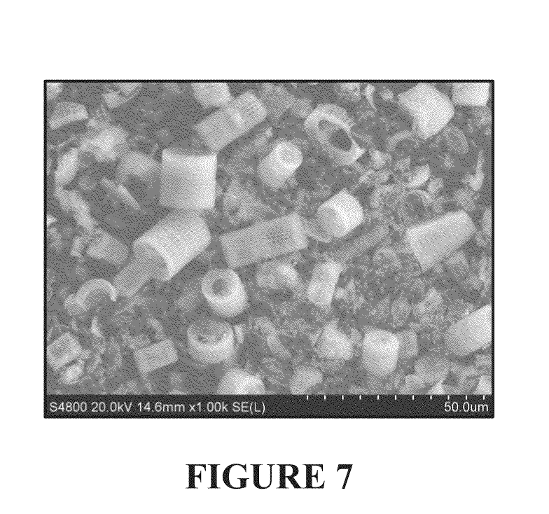

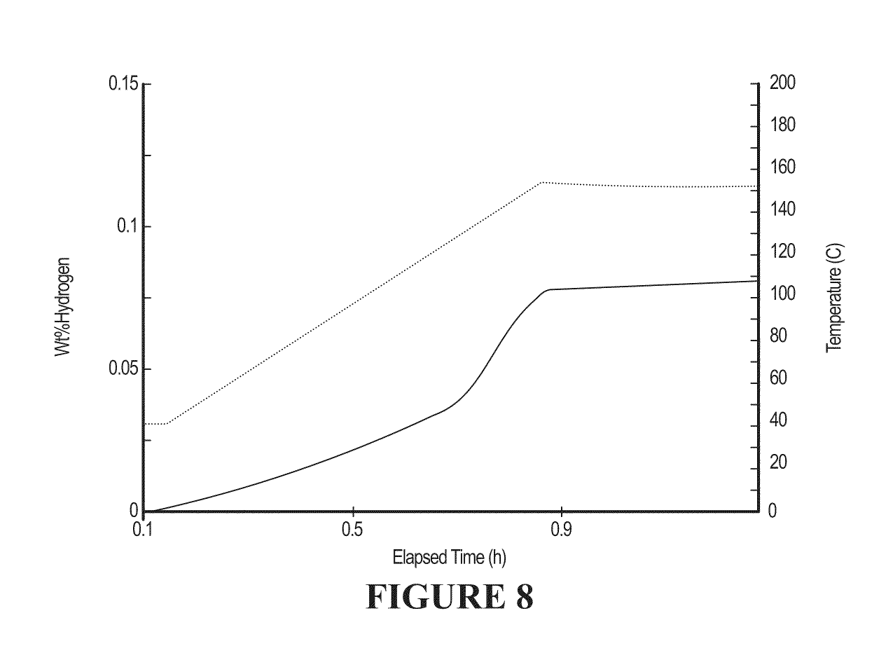

In another experiment, a silica diatomaceous earth sample having 10 wt % palladium (Pd) was prepared according to the examples, which included an oxidization of the resulting solid materials under ambient atmosphere at elevated temperature (350° C.), and the hydrogen storage capacity of this modified diatomaceous earth was examined. Characterization of this composite suggested it was what can be characterized as a Pd-decorated diatomaceous earth sample. The scanning electron microscopic image of this sample is shown in FIG. 7, and the results of the hydrogen sorption measurements are illustrated in FIG. 8. As demonstrated in FIG. 8, this Pd-diatomaceous earth composite demonstrated hydrogen sorption properties as expected for the mass of palladium present, that is, as expected if that amount of palladium metal was present in the absence of the diatomaceous earth. There was no observable hydrogen storage ‘spill-over’ effect or additional hydrogen sorption observed for the composites over the palladium metal.

In further tests, nanostructured biomaterials that were modified by metathesis or exchange reactions were prepared, and their effect on the hydrogen storage performance of hydride sources was examined. These modified diatom or modified diatomaceous earth, for example, samples of anatase (titanium-substituted) diatomaceous earth (TiO₂) could be prepared by a method analogous to that of Unocic et al. (Unocic, R. R.; Zalar, F. M.; Sarosi, P. M.; Cai, Y.; Sandhage, K. H. Chemical Communications 2004, 796-797), which is incorporated by reference herein in its entirety. The displacement or metathesis reaction provides a shape-preserving conversion of the three-dimensional nanoparticle diatom structural framework to form a new nanocrystalline material, in this case, anatase (TiO₂).

One method of forming the anatase diatoms is by reacting titanium tetrafluoride (TiF₄) with the native silica diatoms to initiate the metathesis reaction to form TiO₂ and various silicon-containing by-products such as SiF₄. While not intending to be bound by theory, it appears that the thermodynamics of Si—F versus Ti—F bond energies, as well as Si—O versus Ti—O bond energies, facilitate this reaction because suitable kinetic pathways are present for the exchange or metathesis reaction to occur. Another method of forming the anatase diatoms is by reacting the native silica diatoms with titanium (Ti) metal powder at elevated temperatures, as described in detail in the examples. This type of reaction can also lead to a metathesis or exchange reaction and the displacement structures (TiO₂) mimic the original silica diatom structural pattern including its nanopores, except with the replacement of tetravalent silicon atoms by tetravalent titanium atoms. The reaction of native silica diatoms with titanium (Ti) metal powder at elevated temperatures generally is carried out under more vigorous conditions than the titanium tetrafluoride reaction method, and generally is not as facile or efficient as the titanium tetrafluoride reaction method. Once cooled to room temperature, the modified diatom nanostructure was suitable for catalytic activity and hydrogen storage.

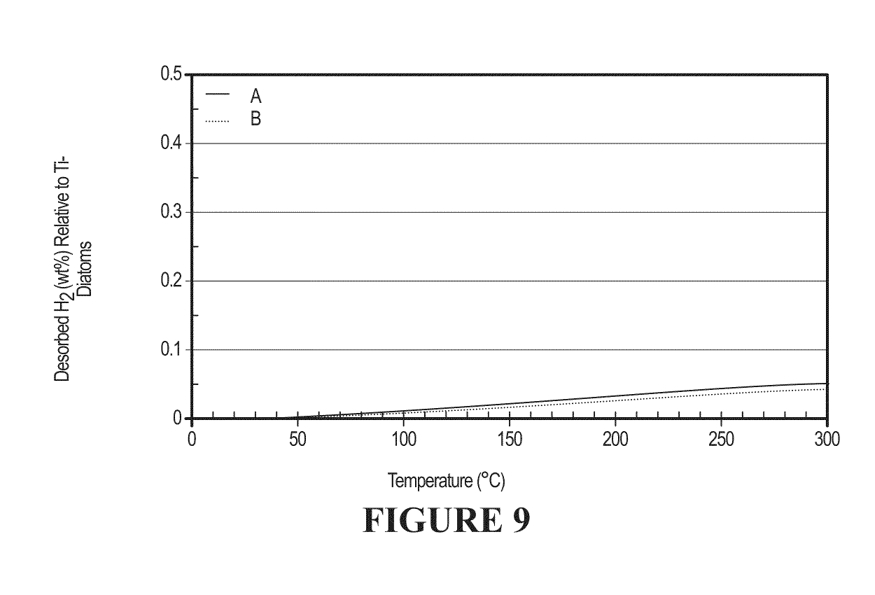

Hydrogen sorption measurements on these Ti-substituted diatom (anatase) samples alone, without forming a composite with a hydride, reveals little hydrogen sorption. For example, a Ti-substituted diatomaceous earth sample was subjected to a series of TPD measurements to determine if the diatoms demonstrate measurable uptake and release of hydrogen. Before each TPD measurement a hydrogen overpressure was applied to sample at 120-130 bar for 12 hours at 150° C., to physiabsorb and/or chemiabsorb hydrogen. In both TPD measurements the temperature was ramped at 2° C./min from 30° C. to 300° C.; followed by maintaining the sample at an isotherm at 300° C. for 1-2 hours. As illustrated in FIG. 9, TPD measurements showed no release of hydrogen after an attempted absorption, with a negligible increase in pressure which is consistent gaseous thermal expansion.

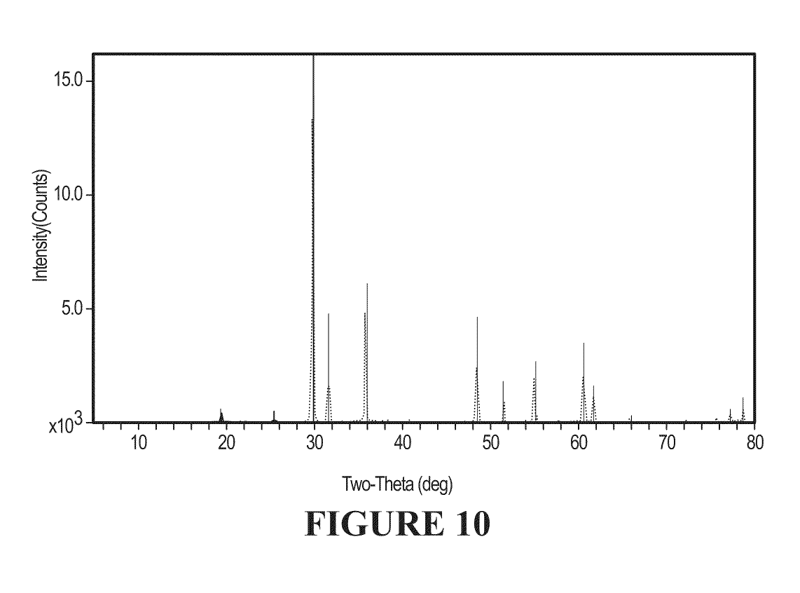

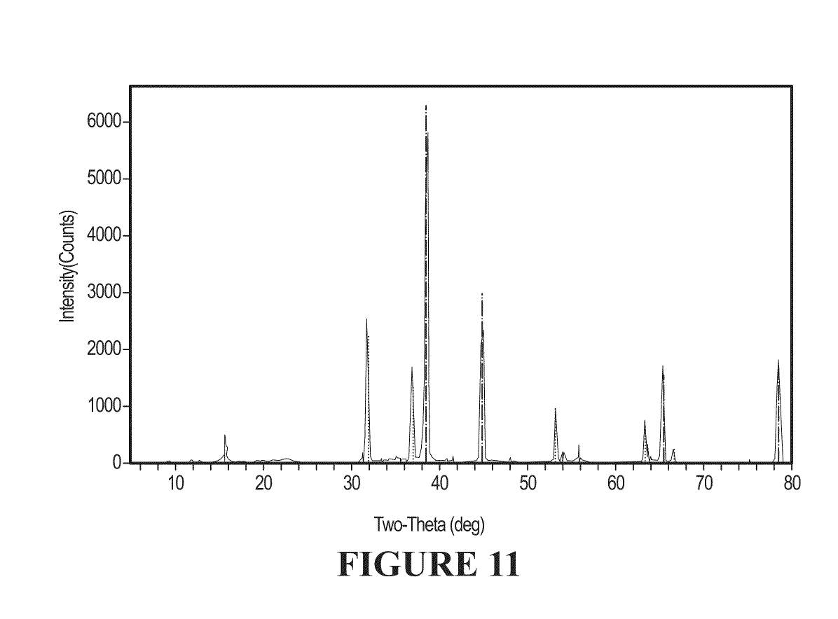

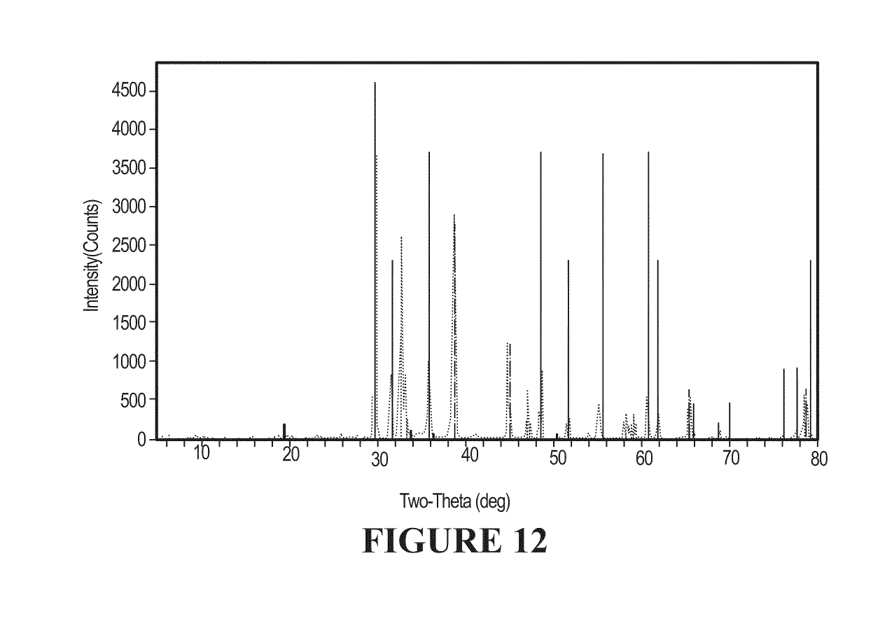

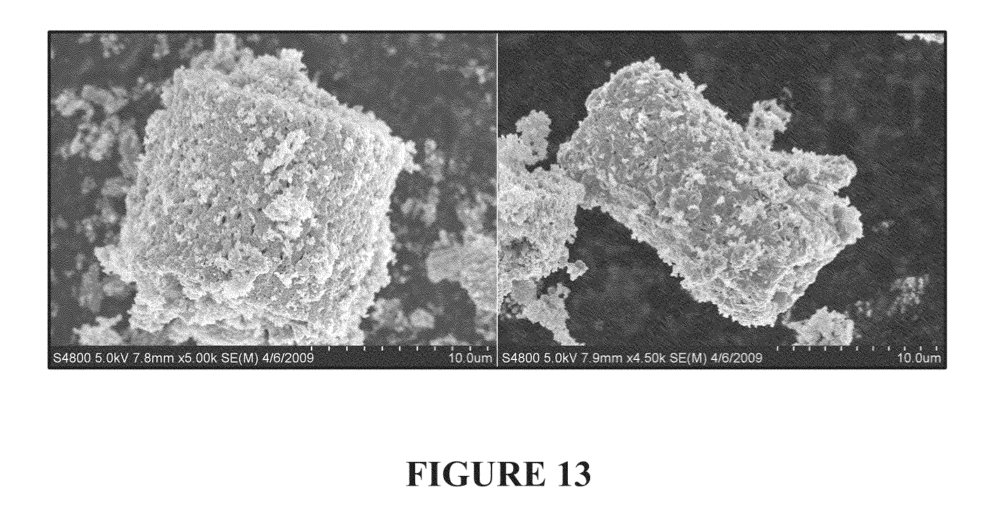

Using the disclosed Ti-substituted diatom (anatase) samples, a composite of NaAlH₄ with 4 mole % anatase diatomaceous earth was prepared and its hydrogen storage capabilities were examined. The preparation, characterization, and catalytic behavior of these composites are detailed in the examples. For example, FIG. 10 illustrates a XRD powder diffraction pattern of an as-prepared Ti-diatom doped (4 mol %) NaAlH₄ sample, which exhibits two peak patterns which match the two initial phases present, anatase and NaAlH₄. After dehydriding (dehydrogenation), the XRD pattern is characterized by two major crystalline phases, aluminum and Na₃AlH₆ (sodium hexahydride aluminate), consistent with NaAlH₄ dehydrogenation as illustrated in Equations 1 and 2 above, FIG. 11. An XRD powder diffraction pattern of the rehydrided material is illustrated in FIG. 12, in which this sample was prepared by exposing the dehydrided sample (FIG. 11) to a hydrogen overpressure at about 120-130 bar for 12 hours at 150° C. FIG. 12 shows the presence of regenerated NaAlH₄, along with Na₃AlH₆, aluminum metal, and trace oxides, products resulting from the partial rehydrogenation (rehydriding) of the NaAlH₄. The scanning electron microscopic image of this post-anneal sample is shown in FIG. 13.

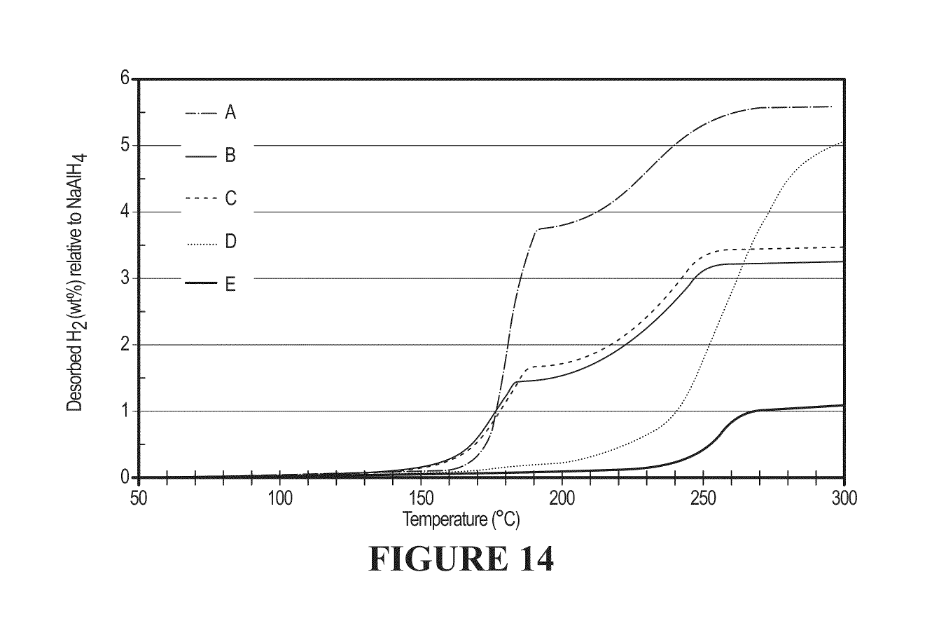

Hydrogen sorption and desorption properties of the NaAlH₄-anatase diatomaceous earth composite were carried out as described in detail in the examples. Thus, a sample of a 4 mole % NaAlH₄-Ti-substitued diatom composite was subjected to a series of temperature programmed desorption measurements (TPD), and between each TPD measurement, a hydrogen overpressure was applied to the sample at 1 elevated temperature to rehydrogenate the material. FIG. 14 illustrates a temperature programmed desorption of Ti-diatom doped (4 mol %) NaAlH₄ composite with a temperature ramp of 2° C./min up to a temperature of 300° C., with standard TPD profiles of pure NaAlH₄ shown for comparison. Among other things, FIG. 14 illustrates the following. (1) The Ti-diatoms effect on NaAlH₄ is catalytic in nature with an increased rate of hydrogen desorption at lower temperatures, for example, from about 150° C. to 180° C., as compared to pure NaAlH₄, which is characterized by hydrogen desorption from about 200° C. to 250° C. The first desorption step is clearly delineated from the slower second dehydrogenation. While not intending to by bound by theory, pure NaAlH₄ has three delineated stages of dehydrogenation for the progressive release of hydrogen, the first two of which are typically illustrated here in Equations 1 and 2 (repeated from above):

NaAlH₄→1/3Na₃AlH₆+2/3Al+H₂ 3.7 wt % H₂ (1)

Na₃AlH₆→3NaH+Al+3/2H₂ 5.6 wt % H₂ (2)

(2) The Ti-diatoms facilitate the uptake of hydrogen as evidenced by the subsequent desorption in the 2^{nd} and 3^{rd} TPD cycles of FIG. 14, of which the latter shows increased absorption. Unlike the hydrogen uptake and release demonstrated for Ti doped hydrides, the present Ti species contains or constitutes a nanostructured anatase phase, whereas previous studies use Ti in the form of a metal or an alloy. While not intending to be theory bound, it is possible that the nanostructured composite of the anatase is instrumental in the combination with the hydride source such as NaAlH₄ in proving a hydrogen storage system, which has favorable hydrogen sorption and desorption thermodynamics and kinetics.

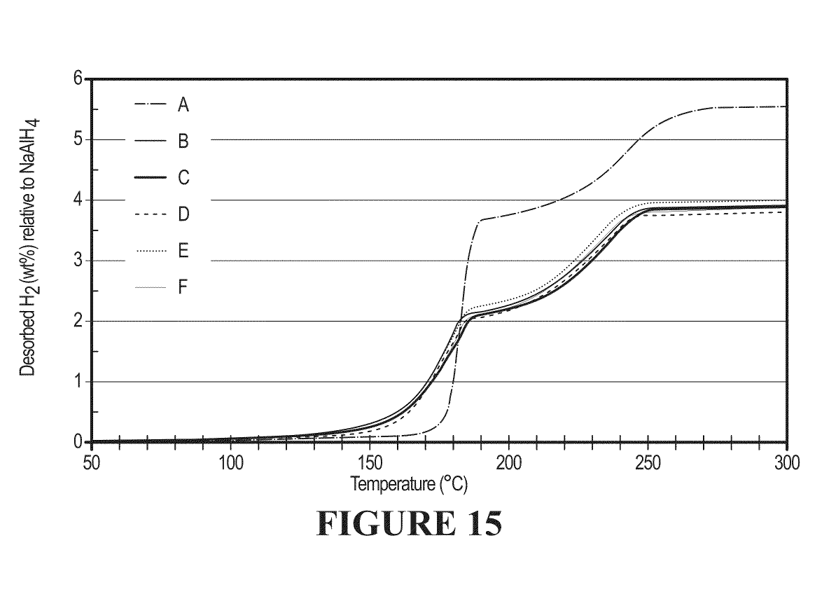

To demonstrate the reversible nature of hydrogen storage for the anatase diatomaceous earth (4 mol %) NaAlH₄ composite, an extended cycling experiment encompassing a sequence of dehydrogenation (dehydriding)-rehydrogenation (rehydriding) steps was undertaken. The TPD plots of these cycling experiments are shown in FIG. 15, with only the temperature programmed desorption step shown. As FIG. 15 demonstrates, the regenerated composite showed strong overlapping desorption measurements, demonstrating a strong regenerative hydrogen storage capacity at ˜3.9 wt %. This highly reproducible hydrogen storage capacity of about 3.9 wt % is remarkably consistent from the first and second temperature programmed desorption measurements (TPD) through the sixth TPD illustrated in FIG. 15, demonstrating the utility, consistency, and reproducibility of these materials for reversible hydrogen storage.

As disclosed in detail in the Examples, a series of anatase samples were used in different combinations with NaAlH₄, and the resulting composites examined for their regenerative hydrogen storage capacity. Among these samples were: Sample A, anatase diatomaceous earth at 4 mol % and 1:1 mol/mol concentrations with NaAlH₄; Sample B, anatase nanopowder (commercial) at 4 mol % and 1:1 mol/mol concentrations with NaAlH₄; and Sample C, sintered anatase bulk powder (commercial); at 4 mol % concentration with NaAlH₄. By way of example, comparing anatase diatom composite sample A (1:1) to anatase nanopowder composite B (1:1) revealed that the total weight percent hydrogen capacity for the nanopowder composite B (1:1) was lower than observed in the anatase diatom composite sample A (1:1), and each subsequent rehydrogenation-dehydrogenation sequence of composite B (1:1) failed to regenerate the same measure of hydrogen storage as present in the previous cycle, indicating that hydrogen storage capacity degrades rapidly with each subsequent cycle. Also by way of example, neither the anatase nanopowder composite B (4 mol %) nor the sintered bulk TiO₂ powder (4 mol %) composite C (4 mol %) showed as favorable results as the Ti-substituted diatomaceous earth (4 mol %) NaAlH₄ composite A (4 mol %) samples.

The examples also provide additional composite materials of nanostructured biomaterials and complex metal hydrides and demonstrate their utility for reversible hydrogen storage. For example, a Ti-substituted diatomaceous earth (4 mol %)-LiBH₄ composite was synthesized and characterized, and pressure conversion temperature (PCT) measurements were carried out. These catalytic studies showed that the Ti-substituted diatomaceous earth appears to exhibit catalytic properties on dehydriding LiBH₄, relative to other materials such as C₆₀, nanoporous carbon, or Mg—Ti additives. See, for example: Yu, X. B.; Grant, D. A.; Walker, G. S. Journal of Physical Chemistry C 2008, 112, 11059-11062; Wellons, M. S.; Berseth, P. A.; Zidan, R. Nanotechnology 2009, 204022 (4 pp); Gross, A. F.; Ahn, C. C.; Van Atta, S. L.; Liu, P.; Vajo, J. J. Nanotechnology 2009, 204005 (6 pp); Xia, G. L.; Guo, Y. H.; Wu, Z.; Yu, X. B. Journal of Alloys and Compounds 2009, 479, 545-548; Cahen, S.; Eymery, J. B.; Janot, R.; Tarascon, J. M. Journal of Power Sources 2009, 189, 902-908. In this aspect, after subsequent hydrogen absorption steps, the TPD measurements showed repeatable albeit decreasing 3-5 wt % hydrogen desorption for this sample. Extended cycling tests illustrate, for example, that the Ti-diatoms effect on LiBH₄ is similar to its effect on NaAlH₄, namely, a catalytic effect is observed with an increased rate of hydrogen desorption at lower temperatures as compared to pure LiBH₄, and an overall greater wt % loss of H₂ as compared to pure LiBH₄.

### Deuterium and Tritium Storage and Catalytic Activity

Some or all of the embodiments of this disclosure can also be applied to the storage, delivery, and catalytic sorption and desorption of deuterium or tritium, in a manner similar to the storage, delivery, and catalytic sorption and desorption of hydrogen. Thus, in the same manner that reversible and repeatable hydrogen sorption and desorption activity can be achieved under relatively mild conditions according to this disclosure, the compositions and methods disclosed here are also applicable to D₂ (also, ²H₂) and T₂ (also ³H₂) storage, delivery, and catalytic sorption and desorption activity. The same hydride sources and nano-biomatrices disclosed for use with hydrogen are also applicable to storage and catalyst sorption and desorption of deuterium and tritium. For example, the catalytic sorption and desorption of deuterium or tritium can be effected starting with a conventional hydride source such as those described herein, and sorption and desorption cycles can be carried out with D₂ or T₂. Alternatively, one could start with a previously enriched source, such as for example, complex deuterides having the nominal formulas LiAlD₄, NaAlD₄, LiBD₄, NaBD₄, and the like, in combination with various nanostructured inorganic materials, such as nanostructured biomaterials. All such embodiments are encompassed by this disclosure. Thus, the present disclosure provides for a catalytic hydrogen storage system comprising:

a sealed environment operable to receive a catalytic composition comprising at least one modified or unmodified nanostructured biomaterial in contact with at least one hydride source;

a gas selected from hydrogen, deuterium, or tritium; and

an environmental control system operable to control the pressure of the gas and/or the temperature within the sealed environment,

wherein the catalytic composition stores the gas upon heating and exposure to the gas; and undergoes reversible gas sorption and desorption at lower temperature and/or pressure as compared to the at least one hydride source in the absence of the at least one modified or unmodified nanostructured biomaterial.

These storage and delivery aspects of deuterium or tritium would be useful for, among other things, any research, manufacturing, or industrial application that requires D₂ or T₂. Examples include, but are not limited to, the synthesis and production of isotopically-enriched deuterium- or tritium-labeled compounds for nuclear magnetic resonance, research, medical diagnostic or treatment purposes, or compounds that serve as isotopic tracers in chemical, biochemical, or environmental sciences. The storage and delivery of deuterium or tritium also would be useful for, among other things, the release and recovery of tritium in nuclear reprocessing, including reprocessing of ordinary spent nuclear fuel where tritium production is not the goal, and in tritium radioluminescent applications, typically in combination with a phosphorescent coatings. Thus, any research, manufacturing, or industrial application that requires D₂ or T₂ could take advantage of the storage and delivery of these catalytic compositions and methods disclosed herein.

### Selected Other Embodiments

Some or all of the embodiments described herein can provide changes in some or all of the following aspects over conventional storage technologies. For example, the following parameters are compared between conventional hydride storage media and the disclosed nanostructured biomaterial-hydride composites, to illustrate selected other embodiments.

Weight density, which is defined herein as the total weight of the hydrogen and conventional hydride metal in terms of deliverable energy stored, can be improved. While the density of hydrogen by volume in a conventional hydride is relatively high, the density by weight can be lower for nanostructured composites with hydrides, because of the weight of the associated metal. Conventional hydrides are about four to five times heavier than gasoline because of the weight of the metals. The storage penalty would be still greater except that hydrogen has about three times the energy density of gasoline. Weight can be especially important in the performance of a vehicle, such as an automobile, truck, bus, boat, or any other hydrogen transport system (e.g., distribution of hydrogen storage canisters by common carrier). Nanostructured biomaterial-hydride composites can increase the weight density of hydrogen storage while achieving lower overall system weight.

Volume density, which is defined herein as the total volume of hydrogen stored in a volume of hydride with respect to the deliverable energy content, can be enhanced. Currently some conventional hydrides can store as much as about half the volume of hydrogen as the equivalent energy of gasoline. While this is up to about twice the amount of hydrogen that can be stored in liquid form, and about three times the hydrogen that can be stored as a gas at approximately 5,000 psi, it nevertheless represents a volume requirement of at least twice that of gasoline. The space and weight requirements can be important in the design of a vehicle such as an automobile or for any hydrogen transport use. Nanostructured biomaterial-hydride composites can increase the volume density in at least two ways: (1) by storing a greater percent of hydrogen in the metal, possibly due to the enormous surface area of the modified or unmodified nanostructured biomaterial; and (2) by engineering more volumetrically absorbing modified nanostructured biomaterial-hydride composites that can store the hydrogen as a hydride. Optimization of the nanostructured composite characteristics can be carried out by way of various embodiments.

Materials costs, which are defined herein as the cost to collect, engineer, and produce commercially suitable materials, can be improved. While manmade nanostructures entail relatively far greater cost to fabricate, naturally occurring nanostructures are biologically reproducible, relatively inexpensive, and a renewable resource that allows a broader range of materials that can be used as catalysts and/or to form hydrides. Substantial natural geological diatom deposits, called diatomite, occur within the United States (Oregon, Nevada, Washington, Florida, California and New Jersey). These deposits provide readily available and controlled resources. Additionally, diatom cultures can be inexpensively cultivated to provide renewable and reproducible nanostructures according to various embodiments of the invention.

Speed of response, which is defined herein as the speed at which hydrogen gas begins to flow upon reaching the heat of decomposition, can be improved or optimized. The speed of response can be important to the smooth performance of a power vehicle. This and other specific hydride performance characteristics can be optimized via the different characteristics that are abundant in naturally occurring nanostructures according to various embodiments of the invention.

Flow rates, which are defined herein as the rate at which hydrogen discharges from the hydride when the heat of decomposition is applied, may be enhanced. The flow rate of the released hydrogen can benefit from the smaller particle sizes of nanostructure particles, since the nanostructures provide relatively more pathways for the exit of the hydrogen gas according to various embodiments of the invention.

Plateau pressure, which is defined herein as the relatively flat region of an S-shaped curve of volume of hydrogen absorbed in the hydride versus pressure (at a constant temperature), also may be adjusted. This is the region in which most of the hydrogen is absorbed with little pressure change. This S-shaped curve of hydrogen absorption versus pressure, plotted at a constant temperature, is known as an isotherm. At relatively higher temperatures, approximately the same curve shifts higher. Plateau pressure for a given temperature can be engineered in conventional hydrides by the selection of metals, alloys, and intermetallic compounds. Using nanostructured biomaterial-hydride composite materials, the plateau pressure can be further tailored and adjusted and can be supplemented with different or similar nanostructure diameters according to various embodiments of the invention.

Plateau slope is defined herein as the slope (usually modestly increasing) of the plateau region of the isotherm, and plateau slope can also be adjusted. For example, plateau slope can be flattened in conventional hydrides with the appropriate activation. It may be possible that many nanostructured biomaterial-hydride composites may forego this annealing or activation step according to various embodiments of the invention.

Plateau Pressure-Temperature Relationship is defined herein as the temperature at which an isotherm pressure plateau occurs, and this relationship may also be altered. The temperatures can be raised or lowered in accordance with the choice of materials in conventional hydrides. Further ranges of flexibility can be obtained with the selection of nanostructure diameters in the nanostructured biomaterial-hydride composites, eliminating or reducing any compromises of other properties according to various embodiments of the invention. These properties may reduce external energy (e.g., waste heat) required for hydrogen desorption from hydrides.

Hysteresis, which is defined herein as the difference in pressure to absorb versus to desorb hydrogen from a hydride, may also be improved in the nanostructured biomaterial-hydride composites. This asymmetry varies among the different conventional hydrides and must be taken into account in designing a system. Dual or multiple bed systems can combine characteristics of specific hydrides for a more economical or efficient overall system. Nanostructured biomaterial-hydride composites with their greater combination of diameters and materials can further tailor the design of the hysteresis of a hydrogen storage system according to various embodiments of the invention.

Ease of activation, which is defined herein as the hydriding of an alloy to form a metal hydride for the first time, can be changed. Some alloys can be activated at ambient temperature, while others are more difficult to activate possibly due to a surface barrier that must first be controlled. Nanostructured biomaterial-hydride composites may directly address this problem by affording a broader range of materials for hydrides, and nanostructure diameters, thus providing relatively greater flexibility for dealing with ease of activation according to various embodiments of the invention.

Withstanding poisoning, which is defined herein as the resistance to deactivation by impure gas streams; e.g. from air, carbon monoxide, or sulfur dioxide, may also be improved. For example, different compounds have different degrees of tolerance for such deactivation. Modified or unmodified (naturally occurring) nanostructure biomaterials, by providing greater combinations of diameters and compositions, can be further tailor-engineer to minimize this problem, boosting the flexibility and performance of the nanostructured biomaterial-hydride composite. For example, certain nanostructures in accordance with embodiments of the invention could be used as scavengers to clean hydrogen or other fuels before or during use in fuel storage, reforming to hydrogen, or in hydrogen fuel cells themselves, to minimize poisoning of hydride-forming materials, catalysts, or electrodes. A mixture of nanoparticles could include hydrides and scavenger. In some instances, a small exchangeable and/or regenerable cartridge of nanostructure material could effectively remove poisons from hydrogen, gasoline, methanol, other fuel, or air. For example, oxygen can be scavenged to increase hydrogen storage levels, and platinum-ruthenium alloy catalyst can be used to prevent poisoning in methanol converters.

Longer cycle life, which is defined herein as the ability to absorb and desorb the same quantity of hydrogen many times with little or no deterioration may be enhanced through the use of nanostructures in forming the nanostructured biomaterial-hydride composites, in accordance with various embodiments of the invention.

Other properties and characteristics, which are taken into account in conventional hydrides, can be further engineered by using nanostructured biomaterial-hydride composites since there are numerous combinations of diameters and materials to choose from according to various embodiments of the invention.

Many further modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### Additional Catalytic Applications

Catalysis, as used herein, is the change in rate of a chemical reaction due to the participation of a substance or composition referred to as a catalyst. The general feature of catalysis is that the catalytic reaction has a lower rate-limiting free energy change to the transition state than the corresponding uncatalyzed reaction, resulting in a larger reaction rate at the same temperature. The current compositions are catalytic in the aspect that the catalyzed reaction has a lower activation energy than the uncatalyzed reaction. Therefore, if the catalyzed reaction is the sorption or desorption of hydrogen, the reaction occurs under milder temperature and/or pressure conditions. As used herein, it is not necessary that more than one stoichiometric turnover of a reaction occur to describe the reaction as catalytic, merely that there has been a change in rate of the reaction due to the participation of the composition referred to as a catalyst, typically resulting in a larger reaction rate at the same temperature. Therefore, this disclosure further provides for a catalytic process, comprising:

providing a catalytic composition comprising at least one modified or unmodified nanostructured biomaterial;

providing at least one reagent to be transformed by a catalytic process; and

contacting, under catalytic conditions, the catalytic composition and the at least one reagent.

Some estimates provide that 90% of all commercially produced chemical products involve catalysts at some stage in the process of their manufacture. Catalytic reactions are also relevant and applicable to many aspects of environmental science, for example, the catalytic converter in automobiles, where the presence of a catalyst allows reactions such as oxidation and/or conversion of oxides of nitrogen to O₂ and N₂ to occur under milder conditions that they would normally occur in the absence of the catalyst. Many reagents and reactions can be involved in the catalytic chemistry using the biomaterials and the composites of this disclosure, for example, catalytic reactions involving hydrogen, protons (H⁺), oxygen, nitrogen, water, carbon monoxide, carbon dioxide, ethylene, olefins generally, acetylene, alkynes generally, acrylates, esters, and the like, and many of these reactions further involve a transition metal-modified nanostructured biomaterial, such as those disclosed herein.

By way of example, particularly useful transition metals that can be used in catalytic reactions of this disclosure include titanium, zirconium, hathium, vanadium, niobium, tantalum, chromium, molybdenum, tungsten, manganese, technetium, rhenium, iron, ruthenium, osmium, cobalt, rhodium, iridium, nickel, palladium, platinum, copper, silver, and gold. The Group 3 elements scandium, yttrium, lanthanum are also useful. Of particular utility in many catalytic reactions such as oxidation, hydrogenation, Fischer-Tropsch catalyst and the like, are the platinum metals, defined herein as ruthenium, osmium, rhodium, iridium, palladium, and platinum, and generally the noble metals, defined herein as ruthenium, osmium, rhodium, iridium, palladium, platinum, silver, and gold. Moreover, the compositions and composites of this disclosure can be used in combination with any number of other “multifunctional” solids, examples of which include but are not limited to, zeolites, graphitic carbon, clay minerals, pillared clays, and the like.

The naturally-occurring nanostructured assemblies in their natural (unmodified) form and in their modified forms are useful in a wide range of catalytic applications. Moreover, the composite materials that combine the disclosed nanostructured assemblies, whether unmodified or modified, with a hydride source are also applicable to a wide range of catalytic applications, including, but not limited to, those in which hydrogenation activity and/or a hydride catalyst or catalytic precursor are desired. By way of example, and not as a limitation, modified diatoms of this disclosure can be used as heterogeneous catalysts or catalyst precursors in catalytic converters to oxidize carbon monoxide and unburnt hydrocarbons and/or to convert oxides of nitrogen to dinitrogen and dioxygen. Also by way of example, and not as a limitation, a composite material of a complex hydride and modified diatoms of this disclosure can be used as heterogeneous catalysts or catalyst precursors in catalytic hydroformylation or Fischer-Tropsch catalysis processes. Moreover, these materials can be utilized in flow reactions or in batch reactions, and they can be deployed alone or in combination with other catalysts in the same reactor or in series or parallel catalytic process.

In one aspect, the nanostructured assemblies of this disclosure and the composite materials comprising the nanostructured assemblies can be employed generally in catalytic hydrogenation, isomerization, carbonylation, hydroformylation, oligomerization, polymerization, oxidation, metathesis, reductive CO polymerization, condensation, alkane activation, and the like. For example, as the nanostructured assemblies are modified and functionalized, the nanoscale structures and nanomatrix properties of the biomaterials can provide an improved catalytic function, for example, when compared with other catalysts in which metal functionalization is primarily a surface phenomenon.

In other aspects, the nanostructured assemblies and the composite materials comprising the nanostructured assemblies can be employed in catalytic process such as Fischer-Tropsch catalysis, hydroformylation, oxychlorination, butadiene synthesis, 1-hexene synthesis, the water-gas shift reaction, hydrogenation, dehydrogenation, isomerization, carbonylation, dimerization, oligomerization, polymerization, oxidation, metathesis, methanol synthesis, formaldehyde synthesis, CO reduction, reductive CO polymerization, condensation, alkane activation, methane activation, methanol homologation, CO activation, formyl intermediate generation, hydroxymethyl intermediate generation, hydroxymethylene intermediate generation, carbide intermediate generation, carbyne intermediate generation, carbene intermediate generation, acetic anhydride synthesis, vinyl acetate synthesis, ethylene glycol synthesis, methyl formate synthesis, methyl methacrylate synthesis, hydrocyanation, cycloaddition reactions, cycloaddition, insertion, ring opening, C—H bond activation, olefin metathesis, the Heck reaction, Friedel-Crafts reactions, and the like. These processes include reactions that are applicable to the catalytic production of biodiesel and related biofuels.

Moreover, when used in conjunction with a chiral reagent, the nanostructured assemblies and the composite materials comprising the nanostructured assemblies can be employed in enantioselective catalysis. In this manner, reactions such as those described herein can be applied to the synthesis of fine chemicals, pharmaceuticals, and other bioactive compounds. The nanostructured assemblies and composite materials also can be used in the hydrogenation of fats, for example, in the preparation of margarine and other foodstuffs.

The nanostructured assemblies and the composite materials comprising the nanostructured assemblies can be extensively employed in petroleum refining and transformations, including but not limited to use as catalysts or catalyst components for alkylation, catalytic cracking, naphtha reforming, steam reforming, hydrogenation, hydrodesulfurization, hydrodenitrogenation, hydrodeoxygenation, hydrodemetallation, and the like. Additional aspects of using the nanostructured assemblies and the composite materials comprising the nanostructured assemblies are provided in the catalytic reactions related to catalytic conversion of combustion gases, including but not limited to, the oxidation of carbon monoxide to carbon dioxide, the oxidation of unburnt hydrocarbons to carbon dioxide and water, and the reduction of nitrogen oxides to nitrogen and oxygen, as examples. By way of example, this disclosure encompasses catalytic converters comprising the modified nanostructured assemblies provided herein, that can be modified with any number of metals such as platinum or rhodium. Such materials can catalyze the break down some of the more harmful byproducts of automobile exhaust, such as, the following reaction:

2CO+2NO→2CO₂+N₂

In other aspects, the nanostructured assemblies and the composite materials comprising the nanostructured assemblies can be employed in catalytic process such as the Haber process, where iron- or other metal-modified nanostructured biomaterials can serve as a catalyst for the synthesis of ammonia from nitrogen and hydrogen. The nanostructured assemblies and the composite materials also can be employed in catalytic process such as esterification, e.g. methyl acetate from acetic acid and methanol. The nanostructured assemblies and the composite materials also can be applied in the context of electrochemical catalysis such as in fuel cell engineering, where various metal-modified nanostructured biomaterials can be used to enhance the rates of both the anodic and cathodic half reactions that comprise the fuel cell.

### General Disclosure Information

All publications and patents mentioned in this disclosure are specifically incorporated herein by reference in their entireties. To the extent that any definition or usage provided by any document incorporated by reference conflicts with the definition or usage provided herein, the definition or usage provided herein controls. Modifications and variations of the disclosed methods and devices will be obvious to those skilled in the art from the foregoing detailed description. Such modifications and variations are intended to come within the scope of the appended claims. Any publications and patents discussed above and throughout the text are provided solely for their disclosure prior to the filing date of the present application. Nothing herein is to be construed as an admission that the inventors are not entitled to antedate such disclosure by virtue of prior invention.

When any disclosure or claim recites “at least” a specified number of elements, for example, a hydrogen storage system comprising “at least one nanostructured biomaterial,” it is intended that the “at least” qualifier apply when describing and disclosing features and properties of any number of the recited element, as the context allows and unless otherwise specified. Therefore, reference to a property of “the” nanostructured biomaterial is also intended to describe the property of “the at least one” nanostructured biomaterial if the context so allows, and unless otherwise stated.

Unless indicated otherwise, when a range of any type is disclosed or claimed, for example a range of the pore sizes, molar ratios, temperatures, pressures, and the like, it is intended to disclose or claim individually each number that such a range could reasonably encompass, including any sub-ranges and combinations of sub-ranges encompassed therein. By way of example, when disclosing that a certain desorption process can be effected at a temperature “from 150° C. to 180° C,” a statement which is interchangeable with “between 150° C. and 180° C,” it is the Applicant(s)' intent is to recite that the desorption process can be effected at a temperature of 150° C., 151° C., 152° C., 153° C., 154° C., 155° C. 156° C., 157° C., 158° C., 159° C., 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., and 180° C., and these methods of describing such a temperature are intended to be used interchangeably. Applicant(s) also intend for the disclosure of a range to reflect, and be interchangeable with, disclosing any and all sub-ranges and combinations of sub-ranges encompassed therein. By way of example only, when disclosing that a certain desorption process can be effected at a temperature from 150° C. to 180° C., such a disclosure literally encompasses a range of temperatures from 150° C. to 158° C., from 153° C. to 160° C., from 170° C. to 180° C., any a combination of any sub-ranges, and so forth. Accordingly, Applicant(s) reserve the right to proviso out or exclude any individual members of any such group, including any sub-ranges or combinations of sub-ranges within the group, if for any reason Applicant(s) choose to claim less than the full measure of the disclosure, for example, to account for a reference that Applicant(s) are unaware of at the time of the filing of the application.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that may be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims.

### EXAMPLES

### General Experimental Procedures and Starting Materials

In the following examples, unless otherwise specified, the reactions and preparations described therein were carried out under an inert atmosphere such as nitrogen and/or argon. Solvents were purchased from commercial sources and were typically dried using standard procedures prior to use. Unless otherwise specified, reagents were obtained from commercial sources. Reference to using baked diatoms or baked diatomaceous earth generally refers to samples that were heated up to about 600° C. for about 2 h to about 96 h. All the deposition steps and reactions between hydrides and oxides were performed under inert atmosphere conditions.

### Example 1

### Preparation and Characterization of a 20 wt % NaAlH₄-Diatomaceous Earth Composite

A 20 wt % NaAlH₄-diatomaceous earth composite (20 wt % diatomaceous earth in the composite and 80 wt % NaAlH₄ in the composite) was synthesized as follows. A solution of NaAlH₄ in THF (6 ml, 1M) was added to a sample of previously baked diatoms (1.1 g) in a single-neck flask inside a glovebox under an inert atmosphere. Initial mixing resulted in the formation of gas, which subsided within one minute. This suspension was allowed to stir at room temperature overnight, after which time the solvent was removed under reduced pressure and the resulting solid was dried under vacuum. A sample of this as-prepared sample was processed for X-ray diffraction (XRD) characterization, the results of which demonstrate the presence of sodium aluminum hydride plus minor phase(s) tentatively identified as oxidation products.

### Example 2

### Hydrogen Sorption Measurements of a 20 wt % NaAlH₄-Diatomaceous Earth Composite

Experiments were carried out to determine the hydrogen sorption and desorption properties of the NaAlH₄ diatomaceous earth composite, and these results were compared to the hydrogen sorption and desorption properties of NaAlH₄ in the absence of diatoms. A sample of a 20 wt % NaAlH₄-diatomaceous earth composite prepared according to Example 1 was subjected to a series of temperature programmed desorption measurements (TPD). The temperature of the sample during each desorption measurement was ramped at 2° C./min from 30° C. to 300° C., followed with an isotherm at 300° C. for 1-2 hours. Between each TPD measurement, a hydrogen overpressure was applied to sample at 120-130 bar for 12 hours at 150° C. to rehydrogenate the material. The results of these TPD measurement cycles are illustrated in FIG. 6, which demonstrate an initial desorption activity, but little capacity for subsequent absorption.

### Example 3

### Preparation and Characterization of a 10 wt % (Synthetic) Palladium-Diatomaceous Earth Composite

A diatomaceous earth sample having 10 wt % palladium (Pd) was prepared by contacting, in the appropriate proportions, samples of diatomaceous earth and palladium acetylacetonate that was dissolved in acetone by incipient wetness. Thus, 1.037 g of prisitine diatoms and 0.311 g of Pd acetylacetonate dissolved in 5 ml of toluene were combined within an inert atmosphere at room temperature. After combining these materials, the solvent was removed under reduced pressure to afford a solid precursor/diatoms composite, which was oxidized in a muffle furnace under ambient atmosphere at 350° C. for 2 h. The resulting oxidized material was loaded into a pressure reactor for cycling with H₂/vacuum to reduce the PdO to PdH/Pd-metal. The material that was removed from the reactor was characterized by a reddish brown color, suggesting the presence of Pd metal nanoparticles decorating the diatomaceous substrate.

An SEM image of this material is provided in FIG. 7, which shows intact diatoms, without noticeable degradation to the fine structure. An X-ray diffraction (XRD) powder pattern of the materials showed a peak pattern consistent with the presence of Pd metal. Energy-Dispersive X-ray Spectroscopy (EDS) measurements of the palladium-diatom composite further confirm the presence of palladium metal at a concentration of ca. 4 wt %. The difference between the measured Pd content of 4 wt % and the concentration expected from the synthetic procedure (ca. 10 wt. %) is possibly due to the high surface area of the diatoms, effectively masking Pd material within the structure. Regardless of the actual weight percent, the material produced in this fashion is referred to as a 10 wt. % palladium-diatomaceous earth composite.

### Example 4

### Hydrogen Sorption Measurements of a 10 wt % Palladium-Diatomaceous Earth Composite

Hydrogen sorption measurements on the Pd-decorated diatomaceous earth sample, prepared according to Example 3, were carried out. A Pd-diatom sample placed in a Hy-Energy Scientific Instruments gas sorption analyzer (or PCT) was saturating with hydrogen at elevated temperature for two hours, then allowing to cool to room-temperature. A temperature programmed desorption ramping to 150° C. resulted in a hydrogen release of ca. 0.05 wt % of the composite. These results are illustrated in FIG. 8, which shows the temperature programmed desorption of the Pd-diatom composite with the temperature ramp (red) of 2° C./min up to 150° C., and the weight percent of hydrogen released (blue). The total calculated amount of hydrogen released was consistent with the hypothetical hydrogen stored as palladium hydride for the metal mass present in the composite (1.4×10⁻⁴ mol H₂ and 1.1×10⁻⁴ mol H₂, respectively). Thus, this 10 wt % Pd-diatomaceous earth composite demonstrated hydrogen sorption properties as expected for the mass of palladium present, that is, as expected if that amount of palladium metal was present in the absence of the diatomaceous earth. There was no observable hydrogen storage ‘spill-over’ effect or additional hydrogen sorption observed for the composites over the palladium metal.

### Example 5

### Preparation of an Anatase Diatomaceous Earth

Samples of anatase (titanium-substituted) diatomaceous earth (TiO₂) were prepared by a method analogous to that of Unocic et al. (Unocic, R. R.; Zalar, F. M.; Sarosi, P. M.; Cai, Y.; Sandhage, K. H. Chemical Communications 2004, 796-797), which is also incorporated by reference herein in its entirety, as provided in this example. This displacement or metathesis reaction constitutes a shape-preserving conversion of the three-dimensional (3-D) nanoparticle structural framework of the silica-based diatom frustules into a new nanocrystalline material, in this case, anatase.

Method A. A sample of titanium tetrafluoride (TiF₄) was combined with filtered and/or milled diatoms and placed in a sealed inert atmosphere inside of a titanium pressure vessel. The vessel was heated to approximately 250° C. to initiate an exothermic metathesis reaction between the diatoms and the TiF₄, in which the temperature increases to about 300° C. At this temperature the reaction and the temperature appeared to stabilize, and the vessel temperature was increased to about 350° C. and maintained at this temperature for about 2 hours, after which time it was allowed to cool to room temperature. After cooling, oxygen or air was purged through the reaction vessel at a rate of about 300 cm³ per minute for approximately 2 hours, and the sample was heated to about 350° C. to remove as much excess TiF₄ as possible, for example, by sublimation. Similar preparations can be carried out using different temperature, pressure, and time conditions. Similar preparations can be carried out in which any number of environmental conditions within the sealed environment can be controlled including, for example, pressure, temperature, reaction time, excess moisture, and any combination thereof.

Method B. A sample of titanium (Ti) metal powder was combined with filtered and/or milled diatoms and placed in a sealed inert atmosphere inside a pressure vessel. The mixture was then heated to approximately 600° C. for about 2 hours, over which time some of the titanium replaced some of the silicon atoms within the diatoms. Reaction conditions can be altered such that some or substantially all of the titanium can replace some or substantially all of the silicon atoms within the diatoms. For example, from about 5% to about 100% of the silicon can be replaced with titanium, if so desired. Thus, a reactive conversion of 3-D SiO₂ nanoparticle-based diatom frustules into nanocrystalline TiO₂ (anatase) was effected via the use of a metathetic gas/silica displacement reaction as described. The displacement structures mimic the original silica diatom structural pattern including its nanopores, except with the replacement of tetravalent silicon atoms by tetravalent titanium atoms. Once cooled to room temperature, the modified diatom nanostructure was suitable for hydrogen storage.

Further Oxidation for Complete Conversion to Anatase. Analyses of the Ti-substituted diatomaceous earth prepared according to Method A or Method B demonstrated incomplete oxidation, that is, conversion to the oxide, of the titanium-substituted material as prepared. Moreover, hydrogen sorption TPD measurements of the as-prepared samples showed no measurable hydrogen sorption. Elemental analysis of the Method A or Method B samples revealed that the as-received samples were largely a titanium based oxide with only trace amounts of silicon. Although spurious elements do not appear to be present, the XRD characterization of these samples demonstrated that the major crystalline phase present was TiOF₂, with a minor anatase phase component. Because this characterization of the as-prepared samples were consistent, the additional step of further oxidation of these samples was instituted to completely convert the as-prepared material to anatase. The initial as-prepared samples were subjected to an additional 12 hours of oxidation within a traditional muffle furnace to complete the formation of anatase. The powder XRD characterization of a post-oxidation sample showed almost complete transformation from the titanium oxyfloride to anatase.

### Example 6

### Preparation and Characterization of a 4 Mole % NaAlH₄-Anatase Diatomaceous Earth Composite

A sample of anatase (titanium-substituted) diatomaceous earth (TiO₂) was prepared according to Example 5 and subjected to the further oxidation or calcification step as provided in Example 5. Post calcification, the Ti-diatoms were loaded “hot” into a single-neck flask and placed under reduced pressure for one hour to remove atmospheric contaminants. Using this materials, a 4 mole % NaAlH₄-anatase diatomaceous earth composite was synthesized as follows. A solution of NaAlH₄ in THF (48.7 ml, 1M) was added to a sample of previously baked Ti-substituted diatoms (0.162 g) in a single-neck flask inside a glovebox under an inert atmosphere. This suspension was allowed to stir at room temperature overnight, after which time the solvent was removed under reduced pressure.

### Example 7

### Powder X-Ray Diffraction (XRD) Characterization of a 4 Mole % NaAlH₄-Anatase Diatomaceous Earth Composite

The powder X-ray diffraction (XRD) patterns of as-prepared, dehydrided (dehydrogenated), and rehydrided (rehydrogenated) samples of 4 mole % NaAlH₄-anatase diatomaceous earth composites were obtained to examine the hydrogen sorption and desorption properties of the NaAlH₄-anatase diatom composite system. These data demonstrated the reversible transition from dehydrided to rehydrided species, as follows.

FIG. 10 illustrates a XRD powder diffraction pattern of an as-prepared Ti-diatom doped (4 mol %) NaAlH₄ sample. The as-prepared sample exhibits two peak patterns which match the two initial phases present, anatase and NaAlH₄. FIG. 11 illustrates a XRD powder diffraction patter of a dehydrided (dehydrogenated) Ti-diatom doped (4 mol %) NaAlH₄ sample. This dehydrided XRD pattern is characterized by two major crystalline phases, aluminum and Na₃AlH₆ (sodium hexahydride aluminate), consistent with NaAlH₄ dehydrogenation as illlustrated in Equations 1 and 2 above. Sodium hydroxide also is present, but as a minor phase. While not theory bound, it is possible that the sodium hydroxide was generated by a small amount of air oxidation during sample characterization.

FIG. 12 illustrates a XRD powder diffraction pattern of the rehydrided material prepared by exposing the dehydrided sample (FIG. 11) to a hydrogen overpressure at about 120-130 bar for 12 hours at 150° C. FIG. 12 shows the presence of regenerated NaAlH₄, along with Na₃AlH₆, aluminum metal, and trace oxides, products resulting from the partial rehydrogenation (rehydriding) of the NaAlH₄.

### Example 8

Comparison of Ti-Substituted Diatoms with Si-Diatoms and Commercial Samples of Anatase

Analyses were conducted to more fully characterize the effect of using Ti-substituted diatomaceous earth. Thus, both silica and titania diatoms were examined, and compared to a commercial sample of anatase nanopowder. Tests were carried out using scanning electron microscopy (SEM), elemental mapping, BET (Brunauer, Emmett, Teller) surface area measurements, and traditional elemental analysis, as described in detail.

### Example 8A

BET Surface Area Measurements. BET measurements for baked SiO₂ diatoms, TiO₂ diatoms prepared according to this disclosure, and a comparative commercial sample of high surface area anatase (TiO₂ powder, Strem Chemical) are presented in Table 1.

TABLE 1
Surface area (BET) analysis of Si- and Ti-diatomaceous earth and
an anatase nanopowder composites with NaAlH₄

| | BET Surface Area | Average Pore Width |
|---|---|---|
| Sample | (m²/g) | (nm) |
| Baked SiO₂ Diatoms | 21.5477 | 16.59 |
| TiO₂ Diatoms, run #1 | 20.9557 | 11.93 |
| TiO₂ Diatoms, run #2 | 20.8005 | 12.22 |
| Strem TiO₂ nanopowder | 506.1209 | 3.39 |

As illustrated in Table 1, the BET measurements of the silica versus titania diatoms reveals a slight decrease in surface area and average pore size as a result of the metathesis of silicon atoms for titanium atoms in forming the anatase nanostructured diatoms, consistent with a loss of diatom fine structure. The BET data indicate the loss of measured surface area of a given sample, consistent with agglomeration, sintering, and the like, of a material's surface, which resulted in a loss of fine surface structure. While the observation of the unusual catalytic activity of the Ti-substituted diatoms might on its face suggest an increase in surface area over that of the native silica diatoms, these results show that total surface area is likely a minor factor in explaining catalytic performance.

For comparative studies, both a high surface area anatase nanopowder and a low surface area bulk sintered anatase powder where purchased from Strem Chemicals, Inc. and tested. The anatase nanopowder had a measured surface area of 506 m²/g, Table 1, which matched fairly well with the certificate of analysis value of 526 m²/g. The minor decrease in surface area is likely due to thermal induced degradation of the fine surface structure as the purchased anatase powder had been treated in an oven (250° C., 6 h) to remove water. The surface area of the bulk sintered anatase powder was not measured, but was assumed to be very low.

### Example 8B

Scanning Electron Microscopy (SEM). The SEM images of titanium substituted diatoms, post anneal, are presented in FIG. 13. These images show clear retention of the basic diatom form, but with a coarsening and annealing of the diatom features. This observation is consistent with the loss of surface area shown by BET analysis.

### Example 8C

Elemental Analysis. Elemental analysis of the silicon oxide diatoms and the Ti-substituted diatoms were undertaken to compare these results with previous measurements and develop complete characterization of both materials. These results are provided in Tables 2 and 3, respectively.

Silicon and oxygen were observed by traditional elemental analysis as the major elemental constituents of the baked, as-received diatoms. Several minor elements, notably aluminum and iron, were also present, Table 2. These results are consistent with the expected elemental composition of diatomaceous earth. A comparison of the titanium-oxide (Ti-substituted) diatoms with the native silicon oxide diatoms show a relative decrease in the concentration of aluminum and iron in the Ti-diatoms, Table 3. While not intending to be theory-bound, one plausible explanation for this observation is that the reactive Ti species may be displacing trace metals as well as silicon during the substitution reaction.

### Example 8D

SEM Elemental Mapping Measurements. The SEM elemental mapping of the Ti-substituted diatoms was also carried out to complement previous measurements and develop complete characterization of this material. The SEM elemental map shows a uniform concentration of titanium and oxygen through the diatom structure, indicative of substantially complete formation of anatase with only trace amounts of aluminum, an observation that is consistent with the traditional digestive elemental analysis. In addition, fluorine appears to be present in the SEM elemental map, likely indicating the presence of minor amounts of TiOF₂, also consistent with the phase determination observed in the XRD powder patterns.

TABLE 2
Elemental analysis of baked, native SiO₂ diatoms. ^{A}

Sample & Analysis

| elemental (wt %) | Al | B | Ca | Cu | Fe | K | Mg | Na | Si | Ti | |
|---|---|---|---|---|---|---|---|---|---|---|---|
| SiO₂ (A) | 1.70 | 0.288 | 0.673 | 0.016 | 0.807 | 0.451 | 0.278 | 0.360 | 42.3 | 0.087 | |
| SiO₂ (B) | 1.71 | 0.282 | 0.654 | 0.016 | 0.813 | 0.440 | 0.278 | 0.362 | 42.3 | 0.087 | |
| Average | 1.71 | 0.285 | 0.664 | 0.016 | 0.810 | 0.446 | 0.278 | 0.361 | 42.3 | 0.087 | |
| oxide (wt %) | Al₂O₃ | B₂O₃ | CaO | CuO | Fe₂O₃ | K₂O | MgO | Na₂O | SiO₂ | TiO₂ | Total |
| SiO₂ (A) | 3.21 | 0.927 | 0.942 | 0.020 | 1.15 | 0.541 | 0.461 | 0.486 | 90.5 | 0.145 | 98.4 |
| SiO₂ (B) | 3.23 | 0.908 | 0.916 | 0.020 | 1.16 | 0.528 | 0.461 | 0.489 | 90.5 | 0.145 | 98.4 |

^{A} Samples were analyzed following Li₂B₄O₇/LiNO₃ and Na₂O₂/NaOH digestions to remove organic and other contaminants.

TABLE 3
Elemental analysis of a TiO₂ diatoms prepared by metathesis. ^{A}

Sample & Analysis

| elemental (wt %) | Al | Ca | Cr | Cu | Fe | Mg | Na | Si | Ti | |
|---|---|---|---|---|---|---|---|---|---|---|
| TiO₂ (A) | 0.695 | 0.255 | 0.010 | 0.255 | 0.291 | 0.100 | 0.140 | 0.159 | 47.2 | |
| TiO₂ (B) | 0.647 | 0.222 | 0.010 | 0.221 | 0.284 | 0.098 | 0.151 | 0.158 | 48.6 | |
| Average | 0.671 | 0.239 | 0.010 | 0.238 | 0.288 | 0.099 | 0.146 | 0.159 | 47.9 | |
| oxide (wt %) | Al₂O₃ | CaO | Cr₂O₃ | CuO | Fe₂O₃ | MgO | Na₂O | SiO₂ | TiO₂ | Total |
| TiO₂ (A) | 1.31 | 0.357 | 0.000 | 0.319 | 0.416 | 0.166 | 0.189 | 0.340 | 78.8 | 81.9 |
| TiO₂ (B) | 1.22 | 0.311 | 0.000 | 0.276 | 0.406 | 0.163 | 0.204 | 0.338 | 81.2 | 84.1 |

^{A} Samples were analyzed following Li₂B₄O₇ digestion to remove organic and other contaminants.

### Example 9

### Hydrogen Sorption Studies of a 4 Mole % NaAlH₄-Anatase Diatomaceous Earth Composite

Hydrogen sorption and desorption properties of the NaAlH₄-anatase diatomaceous earth composite were carried out as follows. A sample of a 4 mole % NaAlH₄-Ti-substitued diatom composite prepared as disclosed herein was subjected to a series of temperature programmed desorption measurements (TPD) to determine the substituted diatom's effect on the hydride. The temperature of the sample during each desorption measurement was ramped at 2° C./min from 30° C. to 300° C., followed with an isotherm at 300° C. for 1-2 hours. Between each TPD measurement, a hydrogen overpressure was applied to sample at 120-130 bar for 12 hours at 150° C. to rehydrogenate the material.

FIG. 14 illustrates a temperature programmed desorption of Ti-diatom doped (4 mol %) NaAlH₄ composite with a temperature ramp of 2° C./min up to a temperature of 300° C., with standard TPD profiles of pure NaAlH₄ shown in dotted lines for comparison. Three desorption profiles are shown for Ti-diatom doped NaAlH₄ composite, and two for the pure NaAlH₄. Both the Ti-diatom-NaAlH₄ composite and the pure NaAlH₄ show a large weight percent change for the initial hydrogen loss, and subsequent smaller weight percent changes for hydrogen desorption after a resorption step. Among other things, FIG. 14 illustrates the following. (1) The Ti-diatoms effect on NaAlH₄ is catalytic in nature with an increased rate of hydrogen desorption at lower temperatures, for example, from about 150° C. to 180° C., as compared to pure NaAlH₄, which is characterized by hydrogen desorption from about 200° C. to 250° C. The first desorption step is clearly delineated from the slower second dehydrogenation. (2) The Ti-diatoms facilitate the uptake of hydrogen as evidenced by the subsequent desorption in the 2^{nd} and 3^{rd} TPD cycles of FIG. 14, of which the latter shows increased absorption.

### Example 10

### Extended Cycling Experiments of a 4 Mol % NaAlH₄-Anatase Diatomaceous Earth Composite

To demonstrate the reversible nature of hydrogen storage for the anatase diatomaceous earth (4 mol %) NaAlH₄ composite, an extended cycling experiment encompassing a sequence of dehydrogenation (dehydriding)-rehydrogenation (rehydriding) steps was undertaken. To maintain meticulous control of the experimental parameters, this extended cycling experiment was performed with manual processing for all absorption/desorption steps.

The cycling measurements involved a series of temperature programmed desorption measurements (TPD) to examine the reversibility and robustness of the Ti-diatom doped (4 mol %) NaAlH₄ sample. The TPD temperature was ramped at 2° C./min from 30° C. to 300° C., followed with an isotherm at 300° C. for 1-2 hours. After each TPD measurement, a hydrogen overpressure was applied to sample at 120-130 bar for 12 hours at 150° C. to rehydrogenate the material. Cycling experiments were conducted for six subsequent iterations on a HyEnergy PCT Pro instrument with the Ti-diatom doped (4 mol %) NaAlH₄ composite prepared according to Example 7. The TPD plots of these cycling experiments are shown in FIG. 15, with only the temperature programmed desorption step shown. As FIG. 15 demonstrates, the regenerated composite showed strong overlapping desorption measurements, demonstrating a strong regenerative hydrogen storage capacity at ˜3.9 wt %. This highly reproducible hydrogen storage capacity of about 3.9 wt % is remarkably consistent from the first and second temperature programmed desorption measurements (TPD) through the sixth TPD illustrated in FIG. 15, demonstrating the utility, consistency, and reproducibility of these materials for reversible hydrogen storage

### Example 11

### Preparation and Characterization of a 1:1 Mol/Mol NaAlH₄-Commercial Anatase Nanopowder Composite, Sample B (1:1)

To better understand the catalytic nature of anatase diatomaceous earth (sample A) in regards to hydrides, a comparative study of the anatase diatoms was conducted, along with a commercially available anatase nanopowder (sample B), and a commercially available anatase sintered bulk powder (sample C). Composite samples using each of these anatase sources were made using stoichiometric quantities (1:1) and catalytic quantities (4 mol %) of each anatase nanopowder, namely anatase diatoms (A) and commercial anatase nanopowder (B) with NaAlH₄. In addition, a composite was made using catalytic quantities (4 mol %) of the sintered anatase bulk powder (C) with NaAlH₄. These samples are designated as follows:

A, anatase diatomaceous earth; 4 mol % and 1:1 mol/mol

B, anatase nanopowder (commercial); 4 mol % and 1:1 mol/mol

C, anatase bulk powder (commercial); 4 mol % TiO₂ in NaAlH₄

The designation 4 mol % refers to a composite of 4 mol % TiO₂ and 96 mol % NaAlH₄ in the composite, and the designation 1:1 refers to a composite of an equimolar ratio of TiO₂ and NaAlH₄ in the composite.

A stoichiometric reaction (1:1, mol/mol) to form a 1:1 mol/mol NaAlH₄-commercial anatase nanopowder composite, sample B (1:1), was carried out as follows. Thermally bulk treated anatase powder (0.550 g, 6.88 mmol) was loaded into a single-neck flask evacuated (30 min) and transferred into an inert atmosphere glovebox. Under an inert atmosphere, ca. 7 ml (0.7 mmol) of a 0.1M NaAlH₄/THF solution was added to the anatase powder, resulting in the immediate formation of a small amount of black-colored material. The slurry was allowed to stir for 3 hrs, the solvent was removed under reduced pressure, and some of the black powder was collected. XRD characterization of the black material showed the starting materials anatase and NaAlH₄ as the crystalline phases, consistent with no major reaction between anatase and NaAlH₄ and/or no new crystalline phase being formed from the combination of commercial anatase and NaAlH₄.

A Thermal Gravimetric Analysis (TGA) characterization of the previously baked (250° C.) commercial anatase powder used to generate the black material was also carried out, which demonstrated residual volatile material (ca. 5 wt %), possibly containing absorbed water, physiabsorbed atmospheric gases, and/or the decomposition of metal oxide hydrates. While not intending to be bound by theory, water and hydrated oxides are expected to be reactive with NaAlH₄, and it is believed their presence results in metal hydride decomposition and the observed discoloration. The XRD powder pattern revealed the lack of a new oxide phase being formed, and the low wt % volatiles measured by TGA suggested that the extent of hydride oxidation resulting from the initial mixing was minor, therefore, it was expected that the experiments to examine catalytic properties of these anatase materials would yield meaningful results.

### Example 12

### Comparative Catalytic Study of a 1:1 Mol/Mol NaAlH₄-Commercial Anatase Nanopowder Composite, Sample B (1:1)

The catalytic properties of a 1:1 anatase nanopowder-NaAlH₄ composite, sample B (1:1) were examined as follows. The 1:1 composite was prepared with a commercially available anatase (TiO₂) nanopowder (sample B) and NaAlH₄, as disclosed in the previous example. According to the usual protocol, a series of temperature programmed desorption measurements (TPD) were carried out to examine the hydrogen storage capacity and the effect of the minor oxidation side products of the B (1:1) composite material, wherein the TPD temperature was ramped at 2° C./min from 30° C. to 300° C., followed with an isotherm at 300° C. for 1-2 hours, which was then followed by a hydrogen overpressure resorption step at 120-130 bar for 12 hours at 150° C., similar to the method of Example 7.

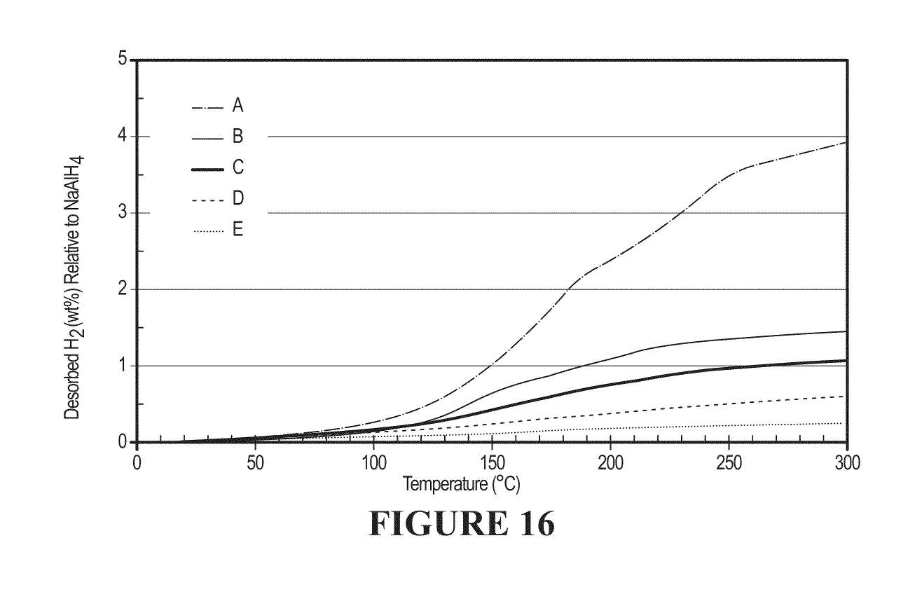

The TPD plots of these cycling experiments are shown in FIG. 16, with only the temperature programmed desorption step shown. These several desorption/absorption cycles demonstrate the anemic initial desorption and the poor non-regenerative cycling capacity of this material. Thus, not only is the total weight percent hydrogen capacity lower than observed in the anatase diatom NaAlH₄ composite, each subsequent rehydrogenation-dehydrogenation sequence fails to regenerate the same measure of hydrogen storage as present in the previous cycle, indicating that hydrogen storage capacity degrades rapidly with each subsequent cycle.

The resultant rehydrided (rehydrogenated) sample was characterized by a powder XRD study, and the pattern showed two weakly ordered phases, titanium hydride and aluminum metal. While we are not theory-bound, we believe that the presence of these two phases is consistent with the reduction of anatase by sodium aluminum hydride, as titanium metal is readily converted to titanium hydride with the application of a hydrogen overpressure and heat. The use of hydride melts for the purpose of “cleaning” oxidized metals surfaces by oxide reduction is known and likely forms a catalytic titanium metal species. Within anatase sodium aluminum hydride composites of low anatase loading (e.g. 4 mol %) the titanium may act catalytically; however, with a high anatase loading as in the 1:1 commercial Ti nanopowder and NaAlH₄ composite, a portion of the hydride initially may be reacted as evident by the decrease initial TPD measurement, <4 wt % H₂ (FIG. 16).

### Example 13

### Preparation and Characterization of a 4 Mol % NaAlH₄-Commercial Anatase Nanopowder Composite, Sample B (4 mol %)

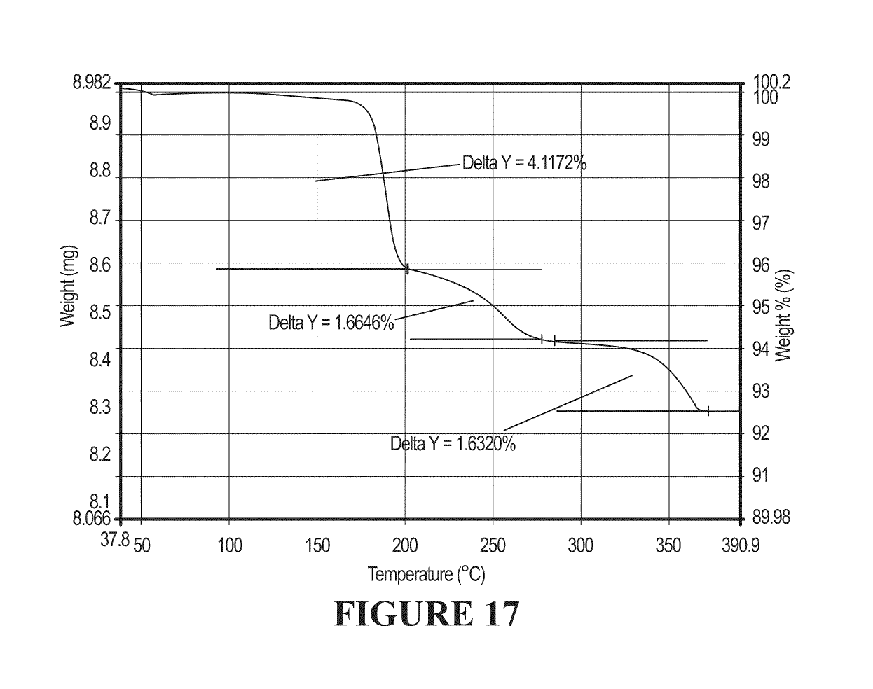

A composite sample using a catalytic quantity (4 mol %) of a commercial anatase nanopowder with NaAlH₄, designated sample B (4 mol %), was prepared by the addition of a 1M NaAlH₄/THF solution (48.7 mL) to a titanium oxide nanopowder (0.162 g, Strem Chemicals), which had been purged of ambient atmosphere. Upon initial combination of the starting materials, a black color appeared. The resulting mixture was allowed to stir for 12 hours, after which time the THF was removed under reduced pressure. This composite sample B (4 mol %) was examined by thermogravimetric (TGA) analysis, FIG. 17. The TGA plot of the composite reveals three discrete weight loss steps. While not theory-bound, it is expected that the these three steps represent the decomposition of the tetrahydride (1^{st} step, ca. 175° C.), the hexahydride (2^{nd} step, ca. 250° C.), and sodium hydride (2^{nd} step, ca. 375° C.), illustrated above as reactions 1, 2, and 3, respectively. Support for the assignment of each TGA step with each of these reactions is the observation that the wt % loss coincides well with the expected amount of hydrogen desorbed. The first step likely includes residual solvent loss in addition to hydrogen desorption. Thus, these characteristic wt % losses of the anatase nanopowder-NaAlH₄ sample mirrors related TPD measurements carried out with Ti-substituted diatomaceous earth-NaAlH₄ composites, further suggesting this assignment.

### Example 14

### Catalytic Study of a 4 Mol % NaAlH₄-Anatase Nanopowder Composite, Sample B (4 Mol %)

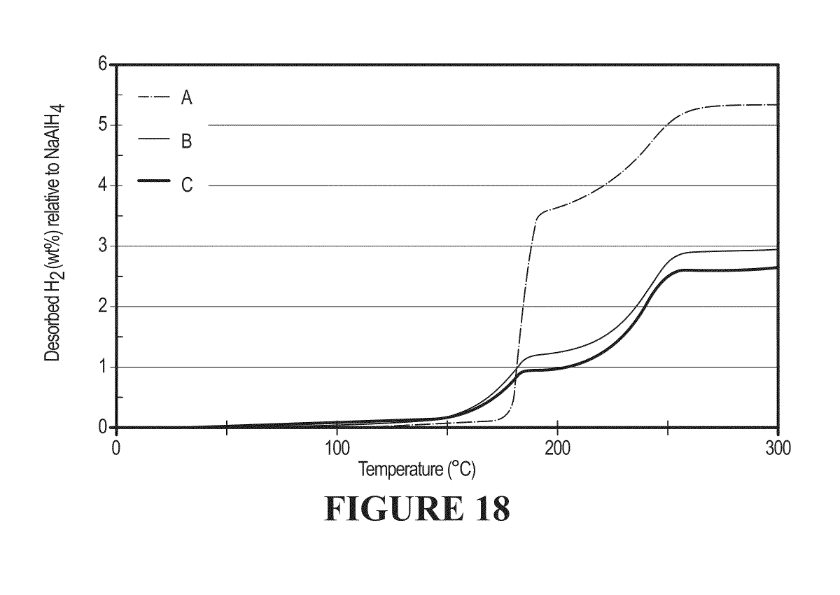

A NaAlH₄-TiO₂ nanopowder (4 mol %) composite, Sample B (4 mol %), was prepared according to Example 14, and subjected to cycling TPD measurement. Cycling TPD studies of this composite revealed similar cycling behavior to NaAlH₄ impregnated with Ti-substituted diatoms, as illustrated in FIG. 18. The temperature of the sample during each desorption measurement was ramped at 2° C./min from 30° C. to 300° C., followed with an isotherm at 300° C. for 1-2 hours. Between each TPD measurement, a hydrogen overpressure was applied to sample at 110-120 bar for 12 hours at 150° C. to rehydrogenate the material. FIG. 18 illustrates a large weight percent change for the initial hydrogen loss, and subsequent smaller weight percent changes for hydrogen desorption after a resorption step, similar to the behavior of the Ti-diatom doped (4 mol %) NaAlH₄ composite under similar conditions.

While not intending to be bound by any theory, it is believed that the reduced desorption of the NaAlH₄—TiO₂ nanopowder (4 mol %) composite for the 2^{nd} and 3^{rd} desorptions (FIG. 18) is likely due to insufficient hydrogen pressure during previous absorption cycle steps (110-120 bar). However, the TPD measurements illustrate the catalytic nature of nanoscale titanium dioxide, in which we can consider the nanoscale size of the TiO₂ to be nanostructural in nature, demonstrating catalytic nanostructured anatase in both diatomaceous and nanopowder forms with similar levels of activity.

### Example 15

### Preparation and Catalytic Study of a 4 Mol % NaAlH₄-Anatase Bulk Powder Composite, Sample C (4 Mol %), Without Nanostructural Features

To further probe the relevance of nanoscale structural features (“nanostructural” features) in the hydrogen sorption properties of the NaAlH₄ composites, a NaAlH₄—TiO₂ powder (4 mol %) composite, sample C (4 mol %), was prepared using a commercial-source sintered anatase ingot, to provide a titania material that did not have nanoscale structural features, or “nanostructural” features. As-received, the commercial-source anatase contained sintered ingots which were briefly (5 min) ball milled to facilitate subsequent mixing with the hydride.

The NaAlH₄—TiO₂ powder (4 mol %) composite (C (4 mol %)) was prepared by the addition of a 1M NaAlH₄/THF solution (48.7 mL) to a titanium oxide powder (0.162 g, Strem Chemicals), which had been purged of ambient atmosphere, allowing the mixture to stir for 12 hours, followed by removal of the THF by reduced pressure. In this preparation, the formation of a black color was not observed upon initial combination of the starting materials.

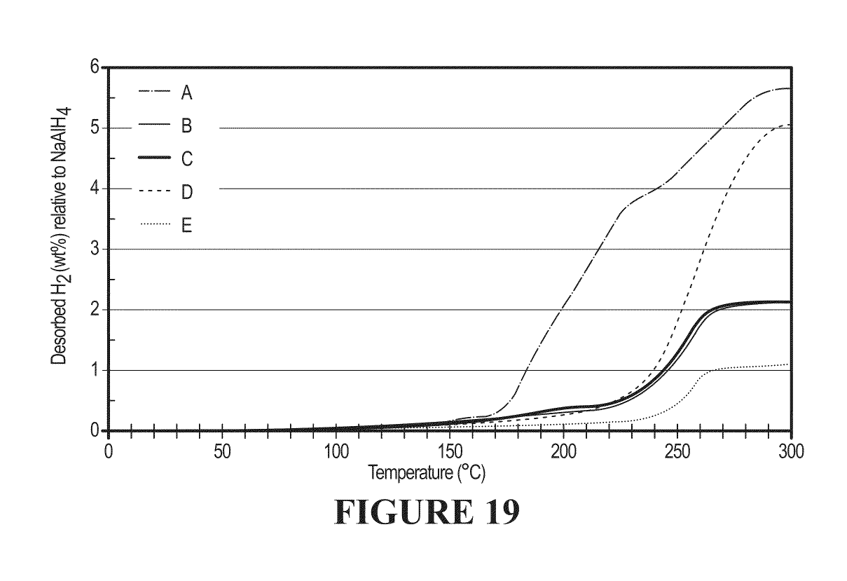

Multiple dehydriding/rehydriding cycling experiments of this composite material were conducted to examine the hydrogen sorption properties, FIG. 19. Thus, FIG. 19 illustrates a temperature programmed desorption of the NaAlH₄—TiO₂ powder (4 mol %) composite (non-nanostructured) with a temperature ramp of 2° C./min up to a temperature of 300° C., with standard TPD profiles of pure NaAlH₄ shown for comparison. Three desorption profiles are shown for Ti-diatom doped NaAlH₄ composite, and two for the pure NaAlH₄. FIG. 19 illustrates the increased desorption kinetics of the NaAlH₄—TiO₂ powder (4 mol %) composite (non-nanostructured) relative to pure NaAlH₄ for all desorption measurements; however, none showed as favorable results as the Ti-substituted diatomaceous earth (4 mol %) NaAlH₄ composite samples.

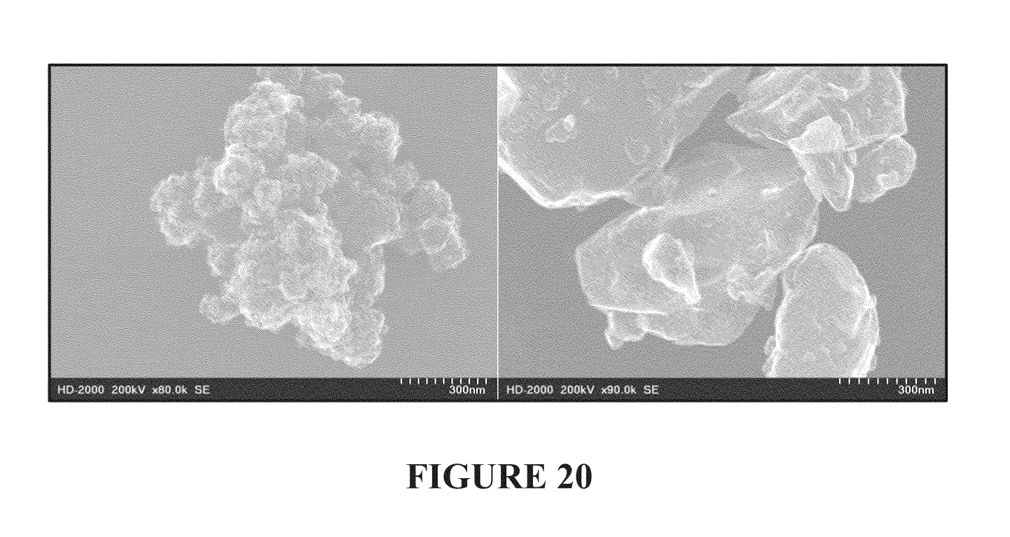

Scanning electron microscopy (SEM) examination was made on the as-received TiO₂ nanopowder and the sintered TiO₂ material post ball milling, both purchased from Strem Chemicals, Inc., the results of which are presented in FIG. 20. These SEM images show striking morphological differences between the two purchased anatase nanopowder and sintered anatase powder materials. The anatase nanopowder (nanostructured) demonstrated a roughness indicative of its high surface area, whereas the sintered anatase (non-nanostructured) was characterized by low surface area ingots, characterized by the presence of flat facets. Thus, the nanostuctural features present in the anatase nanopowder are likely helpful in imparting the high activity and good hydrogen sorption and desorption properties, for example, as observed in the anatase diatoms.

### Example 16

### Preparation and Characterization of a 4 Mol % LiBH₄-Anatase Diatomaceous Earth Composite

A Ti-substituted diatomaceous earth (4 mol %)-LiBH₄ composite was synthesized and characterized by thermogravimetric analysis (TGA) and pressure conversion temperature (PCT) measurements to determine if catalytic activity demonstrated by the Ti-diatoms extends to other hydrides. The sample was prepared by the addition of a LiBH₄ (1.158 g), Ti-substituted diatoms (0.162 g), and THF (ca. 125 ml) into a single-neck flask within an inert atmosphere glovebox. The mixture was allowed stir for 12 hours, with subsequent removal of the THF by reduced pressure, yielding a gray powder.

Preliminary TGA and PCT data was consistent with the as-prepared sample being incompletely dried of the THF solvent, as evidenced by the large initial wt % loss that initiates at about 45° C. as demonstrated by TGA (quantitative), and the residual gas analysis (qualitative RGA) measurements of the released gas as THF. However further weight loss was observed at temperatures >200° C., corresponding to decomposition of the hydride, as the formation of hydrogen was detected. Temperature programmed desorption (TPD) measurements in the original sample indicated a weight loss of 3.3 wt % assigned to H₂ released, relative to the initial sample mass. This observed 3.3 wt % loss can be corrected for the earlier loss of residual THF, to provide a corrected H₂ loss from the composite of ca. 12 wt %, a value which is consistent with the first decomposition step of the LiBH₄.

### Example 17

### Hydrogen Sorption Studies of a 4 Mol % LiBH₄-Anatase Diatomaceous Earth Composite

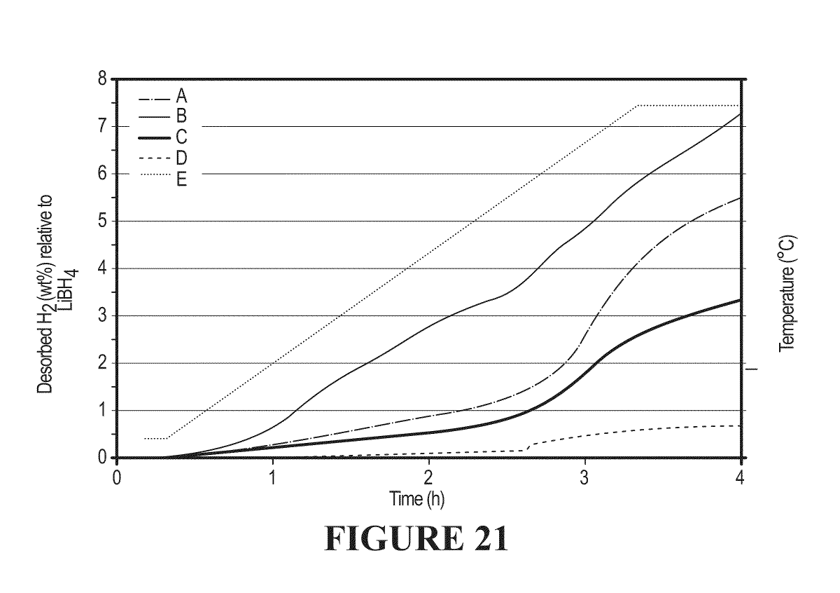

Hydrogen sorption measurements of the a 4 mole % LiBH₄-anatase diatomaceous earth composite prepared as above were carried out in the usual manner disclosed herein. Thus, a temperature ramp of 2° C./min to a temperature of 380° C. was used in the dehydrogenation temperature programmed desorption measurement. These TPD measurements of the composite demonstrated increased dehydrogenation kinetics relative to a pure LiBH₄ standard, as the onset temperature for initial desorption temperature for the as-prepared composite is markedly low (ca. 100° C.) relative to the LiBH₄ standard (ca. 280° C.), FIG. 21. The desorbed ca. 7 wt % hydrogen demonstrated by the composite was lower than the expected first dehydriding step of LiBH₄ (nominally 10-13 wt % hydrogen). After subsequent hydrogen absorption steps (250° C., 12 h, and ca. 120 bar H₂) the 2^{nd} and 3^{rd} TPD measurements show repeatable albeit decreasing 3-5 wt % hydrogen desorption.

Thus, the Ti-substituted diatomaceous earth appears to exhibit catalytic properties on dehydriding LiBH₄, relative to other materials such as C₆₀, nanoporous carbon, or Mg—Ti additives. See, for example: Yu, X. B.; Grant, D. A.; Walker, G. S. Journal of Physical Chemistry C 2008, 112, 11059-11062; Wellons, M. S.; Berseth, P. A.; Zidan, R. Nanotechnology 2009, 204022 (4 pp); Gross, A. F.; Ahn, C. C.; Van Atta, S. L.; Liu, P.; Vajo, J. J. Nanotechnology 2009, 204005 (6 pp); Xia, G. L.; Guo, Y. H.; Wu, Z.; Yu, X. B. Journal of Alloys and Compounds 2009, 479, 545-548; Cahen, S.; Eymery, J. B.; Janot, R.; Tarascon, J. M. Journal of Power Sources 2009, 189, 902-908.

### Example 18

### Extended Cycling Experiments of a 4 Mol % LiBH₄-Anatase Diatomaceous Earth Composite

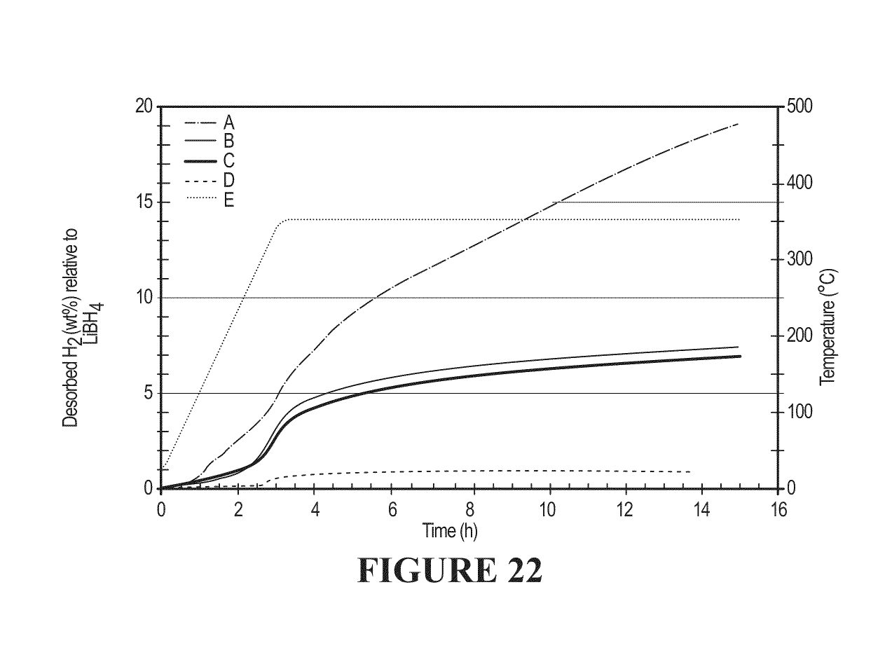

To demonstrate the reversible nature of hydrogen storage for the anatase diatomaceous earth (4 mol %) LiBH₄ composite, an extended cycling experiment encompassing a sequence of dehydrogenation (dehydriding)-rehydrogenation (rehydriding) steps was undertaken, the results of which are illustrated in FIG. 22. These further TPD measurements were conducted with an extended (ca. 15 h) isotherm at 380° C. after the initial temperature ramp. The 1^{st} TPD of the composite showed ca. 18 wt % of hydrogen released, which may represents partial decomposition of LiBH₄ along with the formation of other gaseous species such as residual THF, H₂O, and the like. Following subsequent hydrogen absorption steps (250° C., 12 h, at ca. 120 bar H₂ pressure), the 2^{nd} and 3^{rd} desorption measurements showed repeatable hydrogen desorption and cycling, albeit at a weight loss of about 6-7 wt % H₂. Thus, among other things, FIG. 22 illustrates that the Ti-diatoms effect on LiBH₄ is similar to its effect on NaAlH₄, namely, a catalytic effect is observed with an increased rate of hydrogen desorption at lower temperatures as compared to pure LiBH₄, and an overall greater wt % loss of H₂ as compared to pure LiBH₄.

Again, while not intending to be bound by theory, it is believed that the increase in hydrogen cycling capacity between initial TPD experiments (FIG. 21) and the extended TPD measurements (FIG. 22) is likely a function of Ti diatomaceous earth interpenetration into the hydride matrix. Thus, samples heated for extended periods are likely more homogenous due to increased diffusion. In addition, an extended TPD measurement may capture slow attenuated hydrogen release which may occur in some hydride desorptions.

The claimed invention is:

1. A catalytic composition comprising:
at least one modified or unmodified nanostructured biomaterial; in contact with at least one hydride source;
wherein the catalytic composition undergoes reversible hydrogen sorption and desorption at lower temperature and/or pressure as compared to the at least one hydride source in the absence of the at least one modified or unmodified nanostructured biomaterial.

2. The catalytic composition of claim 1, wherein the at least one nanostructured biomaterial is selected from an unmodified nanostructured silica, a nanostructured silica modified with at least one non-silicon metal, or a combination thereof.

3. The catalytic composition of claim 1, wherein the at least one nanostructured biomaterial is selected from:
a modified nanostructured silica having at least partial substitution of the silicon atoms by non-silicon metal atoms in the nanostructure;
a modified nanostructured silica having non-silicon metal nanoparticles associated with the nanostructured silica; or
a combination thereof.

4. The catalytic composition of claim 1, wherein the at least one nanostructured biomaterial is selected from silica diatoms, titania diatoms, alumina diatoms, zirconia diatoms, magnesia diatoms, boria diatoms, silica-alumina diatoms, titania-alumina diatoms, silica-titania diatoms, silica-zirconia diatoms, silica-magnesia diatoms, silica-alumina-titania diatoms, silica-alumina-zirconia diatoms, boria-alumina diatoms, tungstated zirconia diatoms, alumina-zirconia diatoms, alumina-ceria diatoms, yttria diatoms, lanthana diatoms, ceria diatoms, neodymia diatoms, samaria diatoms, europia diatoms, gadolinia diatoms, praseodymia diatoms, silica-thoria diatoms, silica-berylia diatoms, silica-alumina-thoria diatoms, aluminophosphates, mixed oxides thereof, and any combination thereof.

5. The catalytic composition of claim 1, wherein the at least one nanostructured biomaterial is selected from silica diatomaceous earth, titania diatomaceous earth, zirconia diatomaceous earth, alumina diatomaceous earth, boria diatomaceous earth, yttria diatomaceous earth, lanthana diatomaceous earth, ceria diatomaceous earth, any mixed oxide diatomaceous earth thereof, and any combination thereof.

6. The catalytic composition of claim 1, wherein the at least one hydride source comprises a compound having the formula:
[M^{A}]⁺ⁿₓ[M^{B}H_{y}]^{-m}_{z}, wherein:
M^{A} is a one or more metals selected from at least one Group 1-12 metal, a lanthanide, or an actinide,
+n is the total formal charge on the combined one or more metals;
M^{B} is a Group 13 element,
y is the number of hydride ligands associated with M^{B};
−m is the formal charge on the hydride complex, wherein m=y−3;
and x and z are numbers corresponding to the stoichiometry in the compound, wherein x×n=z×m.

7. The catalytic composition of claim 1, wherein the at least one hydride source comprises a compound having the formula:
[M^{A}]⁺ⁿₓ[M^{B}H_{y}X_{q}]^{-m}_{z}, wherein:
M^{A} is a one or more metals selected from at least one Group 1-12 metal, a lanthanide, or an actinide,
+n is the total formal charge on the combined one or more metals;
M^{B} is a Group 13 element,
y is the number of hydride ligands associated with M^{B};
X, in each occurrence, is selected from halide, tetrahydridoborate, tetrahydridoaluminate, C₁-C₁₂ alkyl, C₆-C₁₂ aryl, C₁-C₁₂ alkoxide, or C₆-C₁₂ aryl oxide;
q is the number of non-hydride ligands associated with M^{B};
−m is the formal charge on the hydride complex, wherein m=y+q−3;
and x and z are numbers corresponding to the stoichiometry in the compound, wherein x×n=z×m.

8. The catalytic composition of claim 1, wherein the at least one hydride source is selected from LiAlH₄, NaAlH₄, KAlH₄, RbAlH₄, CsAlH₄, LiBH₄, NaBH₄, KBH₄, RbBH₄, CsBH₄, NaGaH₄, KGaH₄, Al(BH₄)₃, LiAlH₂(BH₄)₂, Mg(BH₄)₂, Ti(BH₄)₃, Ca(BH₄)₂, Mg(AlH₄)₂, Ti(AlH₄)₄, Zr(BH₄)₃, Mg(AlH₄)₂, Be(AlH₄)₂, Na₂LiAlH₆, CuAlH₄, Mn(AlH₄)₂, Fe(AlH₄)₂, AgAlH₄, Ga(AlH₄)₃, In(AlH₄)₃, Ce(AlH₄)₃, Sn(AlH₄)₄, NaCNBH₃, Li[BEt₃H], Li[AlEt₃H], and any combination thereof.

9. The catalytic composition of claim 1, wherein the at least one nanostructured biomaterial is selected from silica diatoms, titania diatoms, alumina diatoms, or zirconia diatoms, and the at least one hydride source is selected from LiAlH₄, NaAlH₄, KAlH₄, LiBH₄, NaBH₄, or KBH₄.

10. The catalytic composition of claim 1, wherein the at least one nanostructured biomaterial is selected from nanostructured silica or nanostructured titania, and the at least one hydride source is selected from LiAlH₄, NaAlH₄, LiBH₄, or NaBH₄.

11. The catalytic composition of claim 1, wherein the at least one hydride source is selected from LiH, NaH, KH, RbH, CsH, CaH₂, MgH₂, SrH₂, BaH₂, ScH₂, YH₂, LaH₂, AcH₂, Ln^{A}H₂ (Ln^{A} is selected from Ce, Pr, Nd, Sm, Gd, Tb, Dy, Ho, Er, Tm, or Lu), YbH₂, CeH₃, PrH₃, NdH₃, LaH₃, YH₃, Ln^{B}H₃ (Ln^{B} is selected from Sm, Gd, Tb, Dy, Ho, Er, Tm, or Lu), YbH_{2.5}, TiH₂, ZrH₂, HfH₂, Th₄H₁₅, PaH₃, UH₃, VH, NbH, TaH, VH₂, NbH₂, CrH, CrH₂, NiH, PdH, ZnH₂, CdH₂, HgH₂, BeH₂, AlH₃, GaH_{X ca. 3}, and any combination thereof.

12. A catalytic hydrogen storage system comprising:
a sealed environment operable to receive a catalytic composition comprising at least one modified or unmodified nanostructured biomaterial in contact with at least one hydride source;
a gas selected from hydrogen, deuterium, or tritium; and
an environmental control system operable to control the pressure of the gas and/or the temperature within the sealed environment,
wherein the catalytic composition stores the gas upon heating and exposure to the gas;
and undergoes reversible gas sorption and desorption at lower temperature and/or pressure as compared to the at least one hydride source in the absence of the at least one modified or unmodified nanostructured biomaterial.

13. The catalytic hydrogen storage system of claim 12, wherein the environmental control system is operable to release at least a portion of the stored gas from within the sealed environment by a process comprising subjecting the at least one modified or unmodified nanostructured biomaterial in contact with at least one hydride source to a predefined temperature and pressure.

14. The catalytic hydrogen storage system of claim 12, wherein the environmental control system is operable to re-expose the at least one modified or unmodified nanostructured biomaterial in contact with at least one hydride source to the gas; and store at least a portion of the gas in the hydrogen storage medium.

15. The catalytic hydrogen storage system of claim 12, wherein the at least one nanostructured biomaterial is selected from an unmodified nanostructured silica or a nanostructured silica modified with at least one non-silicon metal.

16. The catalytic hydrogen storage system of claim 12, wherein the at least one nanostructured biomaterial is selected from:
a modified nanostructured silica having at least partial substitution of the silicon atoms by non-silicon metal atoms in the nanostructure;
a modified nanostructured silica having non-silicon metal nanoparticles associated with the nanostructured silica; or
a combination thereof.

17. The catalytic hydrogen storage system of claim 12, wherein the at least one nanostructured biomaterial is selected from silica diatoms, titania diatoms, alumina diatoms, zirconia diatoms, magnesia diatoms, boria diatoms, silica-alumina diatoms, titania-alumina diatoms, silica-titania diatoms, silica-zirconia diatoms, silica-magnesia diatoms, silica-alumina-titania diatoms, silica-alumina-zirconia diatoms, boria-alumina diatoms, tungstated zirconia diatoms, alumina-zirconia diatoms, alumina-ceria diatoms, yttria diatoms, lanthana diatoms, ceria diatoms, neodymia diatoms, samaria diatoms, europia diatoms, gadolinia diatoms, praseodymia diatoms, silica-thoria diatoms, silica-berylia diatoms, silica-alumina-thoria diatoms, aluminophosphates, mixed oxides thereof, and any combination thereof.

18. The catalytic hydrogen storage system of claim 12, wherein the at least one hydride source comprises a compound having the formula:
[M^{A}]⁺ⁿₓ[M^{B}H_{y}]^{-m}_{z}, wherein:
M^{A} is a one or more metals selected from at least one Group 1-12 metal, a lanthanide, or an actinide,
+n is the total formal charge on the combined one or more metals;
M^{B} is a Group 13 element,
y is the number of hydride ligands associated with M^{B} in the hydride complex;
−m is the formal charge on the hydride complex, wherein m=y−3;
and x and z are numbers corresponding to the stoichiometry in the compound, wherein x×n=z×m.

19. The catalytic hydrogen storage system of claim 12, wherein the at least one hydride source is selected from LiAlH₄, NaAlH₄, KAlH₄, RbAlH₄, CsAlH₄, LiBH₄, NaBH₄, KBH₄, RbBH₄, CsBH₄, NaGaH₄, KGaH₄, Al(BH₄)₃, LiAlH₂(BH₄)₂, Mg(BH₄)₂, Ti(BH₄)₃, Fe(BH₄)₃, Ca(BH₄)₂, Mg(AlH₄)₂, Ti(AlH₄)₄, Zr(BH₄)₃, Mg(AlH₄)₂, Be(AlH₄)₂, Na₂LiAlH₆, CuAlH₄, Mn(AlH₄)₂, Fe(AlH₄)₂, AgAlH₄, Ga(AlH₄)₃, In(AlH₄)₃, Ce(AlH₄)₃, Sn(AlH₄)₄, NaCNBH₃, Li[BEt₃H], Li[AlEt₃H], and any combination thereof.

20. The catalytic hydrogen storage system of claim 12, wherein the at least one hydride source is selected from LiH, NaH, KH, RbH, CsH, CaH₂, MgH₂, SrH₂, BaH₂, ScH₂, YH₂, LaH₂, AcH₂, Ln^{A}H₂ (Ln^{A} is selected from Ce, Pr, Nd, Sm, Gd, Tb, Dy, Ho, Er, Tm, or Lu), YbH₂, CeH₃, PrH₃, NdH₃, LaH₃, YH₃, Ln^{B}H₃ (Ln^{B} is selected from Sm, Gd, Tb, Dy, Ho, Er, Tm, or Lu), YbH_{2.5}, TiH₂, ZrH₂, HfH₂, Th₄H₁₅, PaH₃, UH₃, VH, NbH, TaH, VH₂, NbH₂, CrH, CrH₂, NiH, PdH, ZnH₂, CdH₂, HgH₂, BeH₂, AlH₃, GaH_{X ca. 3}, and any combination thereof.

21. A method for storing hydrogen, comprising:
providing a catalytic composition comprising at least one modified or unmodified nanostructured biomaterial in contact with at least one hydride source, wherein the catalytic composition undergoes reversible hydrogen sorption and desorption at lower temperature and/or pressure as compared to the at least one hydride source in the absence of the at least one modified or unmodified nanostructured biomaterial;
exposing the catalytic composition to hydrogen; and
storing at least a portion of the hydrogen in the catalytic composition.

22. The method for storing hydrogen of claim 21, wherein the at least one nanostructured biomaterial is selected from an unmodified nanostructured silica or a nanostructured silica modified with at least one non-silicon metal.

23. The method for storing hydrogen of claim 21, wherein the at least one nanostructured biomaterial is selected from:
a modified nanostructured silica having at least partial substitution of the silicon atoms by non-silicon metal atoms in the nanostructure;
a modified nanostructured silica having non-silicon metal nanoparticles associated with the nanostructured silica; or
a combination thereof.

24. The method for storing hydrogen of claim 21, wherein the at least one nanostructured biomaterial is selected from silica diatoms, titania diatoms, alumina diatoms, zirconia diatoms, magnesia diatoms, boria diatoms, silica-alumina diatoms, titania-alumina diatoms, silica-titania diatoms, silica-zirconia diatoms, silica-magnesia diatoms, silica-alumina-titania diatoms, silica-alumina-zirconia diatoms, boria-alumina diatoms, tungstated zirconia diatoms, alumina-zirconia diatoms, alumina-ceria diatoms, yttria diatoms, lanthana diatoms, ceria diatoms, neodymia diatoms, samaria diatoms, europia diatoms, gadolinia diatoms, praseodymia diatoms, silica-thoria diatoms, silica-berylia diatoms, silica-alumina-thoria diatoms, aluminophosphates, mixed oxides thereof, and any combination thereof.

25. The method for storing hydrogen of claim 21, wherein the at least one hydride source comprises a compound having the formula:
[M^{A}]⁺ⁿₓ[M^{B}H_{y}]^{-m}_{z}, wherein:
M^{A} is a one or more metals selected from at least one Group 1-12 metal, a lanthanide, or an actinide,
+n is the total formal charge on the combined one or more metals;
M^{B} is a Group 13 element,
y is the number of hydride ligands associated with M^{B} in the hydride complex;
−m is the formal charge on the hydride complex, wherein m=y−3;
and x and z are numbers corresponding to the stoichiometry in the compound, wherein x×n=z×m.

26. The method for storing hydrogen of claim 21, wherein the at least one hydride source is selected from LiAlH₄, NaAlH₄, KAlH₄, RbAlH₄, CsAlH₄, LiBH₄, NaBH₄, KBH₄, RbBH₄, CsBH₄, NaGaH₄, KGaH₄, Al(BH₄)₃, LiAlH₂(BH₄)₂, Mg(BH₄)₂, Ti(BH₄)₃, Fe(BH₄)₃, Ca(BH₄)₂, Mg(AlH₄)₂, Ti(AlH₄)₄, Zr(BH₄)₃, Mg(AlH₄)₂, Be(AlH₄)₂, Na₂LiAlH₆, CuAlH₄, Mn(AlH₄)₂, Fe(AlH₄)₂, AgAlH₄, Ga(AlH₄)₃, In(AlH₄)₃, Ce(AlH₄)₃, Sn(AlH₄)₄, NaCNBH₃, Li[BEt₃H], Li[AlEt₃H], and any combination thereof.

27. The method for storing hydrogen of claim 21, wherein the at least one hydride source is selected from LiH, NaH, KH, RbH, CsH, CaH₂, MgH₂, SrH₂, BaH₂, ScH₂, YH₂, LaH₂, AcH₂, Ln^{A}H₂ (Ln^{A} is selected from Ce, Pr, Nd, Sm, Gd, Tb, Dy, Ho, Er, Tm, or Lu), YbH₂, CeH₃, PrH₃, NdH₃, LaH₃, YH₃, Ln^{B}H₃ (Ln^{B} is selected from Sm, Gd, Tb, Dy, Ho, Er, Tm, or Lu), YbH_{2.5}, TiH₂, ZrH₂, HfH₂, Th₄H₁₅, PaH₃, UH₃, VH, NbH, TaH, VH₂, NbH₂, CrH, CrH₂, NiH, PdH, ZnH₂, CdH₂, HgH₂, BeH₂, AlH₃, GaH_{X ca. 3}, and any combination thereof.

28. The method for storing hydrogen of claim 21, further comprising:
releasing at least a portion of the hydrogen from the catalytic composition by subjecting the catalytic hydrogen storage system to a predefined temperature and pressure.

29. The method for storing hydrogen of claim 21, wherein the catalytic hydrogen storage system further comprises:
a sealed environment operable to receive the catalytic composition;
an environmental control system operable to control the pressure of hydrogen and/or temperature within the sealed environment,
wherein the environmental control system is operable to release at least a portion of the stored hydrogen from within the sealed environment by a process comprising subjecting the catalytic composition to a predefined temperature and pressure.

30. The method for storing hydrogen of claim 21, wherein the environmental control system is operable to re-expose the catalytic composition to hydrogen; and store at least a portion of the hydrogen in the catalytic composition.

31. A catalytic process, comprising:
providing a catalytic composition comprising at least one modified or unmodified nanostructured biomaterial;
providing at least one reagent to be transformed by a catalytic process; and
contacting, under catalytic conditions, the catalytic composition and the at least one reagent.

32. The catalytic process of claim 31, wherein the catalytic composition further comprises at least one hydride source in contact with the at least one modified or unmodified nanostructured biomaterial.

33. The catalytic process of claim 31, wherein the a catalytic process comprises hydrogenation, dehydrogenation, isomerization, carbonylation, hydroformylation, dimerization, oligomerization, polymerization, oxidation, metathesis, condensation, alkane activation, Fischer-Tropsch catalysis, hydroformylation, oxychlorination, butadiene synthesis, 1-hexene synthesis, the water-gas shift reaction, methanol synthesis, formaldehyde synthesis, CO reduction, reductive CO polymerization, condensation, alkane activation, methane activation, methanol homologation, CO activation, formyl intermediate generation, hydroxymethyl intermediate generation, hydroxymethylene intermediate generation, carbide intermediate generation, carbyne intermediate generation, carbene intermediate generation, acetic anhydride synthesis, vinyl acetate synthesis, ethylene glycol synthesis, methyl formate synthesis, methyl methacrylate synthesis, hydrocyanation, cycloadditions, insertion, ring opening, C—H bond activation, olefin metathesis, the Heck reaction, Friedel-Crafts reactions, conversion of nitrogen oxides to O₂ and N₂, reaction of CO and NO to form CO₂ and N₂, CO oxidation, hydrocarbon oxidation, enantioselective oxidation, enantioselective hydrogenation, alkylation, catalytic cracking, naphtha reforming, steam reforming, hydrogenation, hydrodesulfurization, hydrodenitrogenation, hydrodeoxygenation, hydrodemetallation, the Haber process, esterification, methyl acetate synthesis, a fuel cell anodic half-reaction, or a fuel cell cathodic half-reaction.
